(19) United States
(12) Patent Application Publication
(10) Pub. No.: US 2017/0085921 A1
(43) Pub. Date: Mar. 23, 2017

(54) METHOD FOR DECODING A SERVICE GUIDE

(71) Applicant: Sharp Kabushiki Kaisha, Sakai City, Osaka (JP)

(72) Inventor: Sachin G. DESHPANDE, Camas, WA (US)

(21) Appl. No.: 15/310,873

(22) PCT Filed: May 12, 2015
(86) PCT No.: PCT/JP2015/002415

§ 371 Date: Nov. 14, 2016

Related U.S. Application Data
(60) Provisional application No. 62/000,470, filed on May 19, 2014.

(51) Int. Cl. H04N 21/2362; H04N 21/6336; H04N 21/262; H04N 21/435; H04N 21/235; H04N 21/258

(52) U.S. Cl. CPC H04N 21/2362; H04N 21/2358; H04N 21/25833; H04N 21/26283; H04N 21/435; H04N 21/6336

(57) ABSTRACT

According to the present invention, a method for decoding a service guide which includes additional syntax elements and/or attributes for said service guide is provided. These new elements and/or attributes enable the system to provide users with further information regarding the services (for example, multi-view service information, alternative audio tracks, alternative subtitles, and so forth).

### TECHNICAL FIELD

The present disclosure relates generally to a service guide.

### BACKGROUND ART

A broadcast service is capable of being received by all users having broadcast receivers. Broadcast services can be roughly divided into two categories, namely, a radio broadcast service carrying only audio and a multimedia broadcast service carrying audio, video and data. Such broadcast services have developed from analog services to digital services. More recently, various types of broadcasting systems (such as a cable broadcasting system, a satellite broadcasting system, an Internet based broadcasting system, and a hybrid broadcasting system using both a cable network, Internet, and/or a satellite) provide high quality audio and video broadcast services along with a high-speed data service. Also, broadcast services include sending and/or receiving audio, video, and/or data directed to an individual computer and/or group of computers and/or one or more mobile communication devices.

In addition to more traditional stationary receiving devices, mobile communication devices are likewise configured to support such services. Such configured mobile devices have facilitated users to use such services while on the move, such as mobile phones. An increasing need for multimedia services has resulted in various wireless/broadcast services for both mobile communications and general wire communications. Further, this convergence has merged the environment for different wire and wireless broadcast services.

### SUMMARY OF INVENTION

### Technical Problem

Open Mobile Alliance (OMA), is a standard for interworking between individual mobile solutions, serves to define various application standards for mobile software and Internet services. OMA Mobile Broadcast Services Enabler Suite (OMA BCAST) is a specification designed to support mobile broadcast technologies. The OMA BCAST defines technologies that provide IP-based mobile content delivery, which includes a variety of functions such as a service guide, downloading and streaming, service and content protection, service subscription, and roaming.

### Solution to Problem

According to the present invention, there is provided a method for decoding a service guide associated with a video bitstream comprising:

(a) receiving a service description within said service guide;

(b) receiving a video extension within said service description that is mandatory for network support and is mandatory for terminal support;

(c) wherein said video extension has a data type of string used to describe the role of the video extension as a textual description regarding the said video extension;

(d) receiving an audio extension within said service description that is mandatory for network support and is mandatory for terminal support;

(e) wherein said audio extension has a data type of string used to describe the role of the audio extension as a textual description regarding the said audio extension;

(f) receiving a closed caption extension within said service description that is mandatory for network support and is mandatory for terminal support;

(g) wherein said closed caption extension has a data type of string used to describe the role of the closed caption extension as a textual description intended regarding the said closed caption extension;

(h) decoding said service guide including said video extension, said audio extension, and said closed caption extension.

### Advantageous Effects of Invention

The foregoing and other objectives, features, and advantages of the invention will be more readily understood upon consideration of the following detailed description of the invention, taken in conjunction with the accompanying drawings.

### BRIEF DESCRIPTION OF DRAWINGS

FIG. 1 is a block diagram illustrating logical architecture of a BCAST system specified by OMA BCAST working group in an application layer and a transport layer.

FIG. 2 is a diagram illustrating a structure of a service guide for use in the OMA BCAST system.

FIG. 2A is a diagram showing cardinalities and reference direction between service guide fragments.

FIG. 3 is a block diagram illustrating a principle of the conventional service guide delivery method.

FIG. 4 illustrates description scheme.

FIG. 5 illustrates a ServiceMediaExtension with MajorChannelNum and MinorChannelNum.

FIG. 6 illustrates a ServiceMediaExtension with an Icon.

FIG. 7 illustrates a ServiceMediaExtension with a url.

FIG. 8 illustrates a ServiceMediaExtension with MajorChannelNum, MinorChannelNum, Icon, and url.

FIG. 9A illustrates AudioLanguage elements and TextLanguage elements.

FIG. 9B illustrates AudioLanguage elements and TextLanguage elements.

FIG. 9C illustrates AudioLanguage elements and TextLanguage elements.

FIG. 10A illustrates AudioLanguage elements and TextLanguage elements.

FIG. 10B illustrates AudioLanguage elements and TextLanguage elements.

FIG. 10C illustrates AudioLanguage elements and TextLanguage elements.

FIG. 11A illustrates a syntax structure for an access fragment.

FIG. 11B illustrates a syntax structure for an access fragment.

FIG. 11C illustrates a syntax structure for an access fragment.

FIG. 11D illustrates a syntax structure for an access fragment.

FIG. 11E illustrates a syntax structure for an access fragment.

FIG. 11F illustrates a syntax structure for an access fragment.

FIG. 11G illustrates a syntax structure for an access fragment.

FIG. 11H illustrates a syntax structure for an access fragment.

FIG. 11I illustrates a syntax structure for an access fragment.

FIG. 11J illustrates a syntax structure for an access fragment.

FIG. 11K illustrates a syntax structure for an access fragment.

FIG. 11L illustrates a syntax structure for an access fragment.

FIG. 11M illustrates a syntax structure for an access fragment.

FIG. 11N illustrates a syntax structure for an access fragment.

FIG. 11O illustrates a syntax structure for an access fragment.

FIG. 11P illustrates a syntax structure for an access fragment.

FIG. 11Q illustrates a syntax structure for an access fragment.

FIG. 12A illustrates syntax structures for a type element.

FIG. 12B illustrates syntax structures for a type element.

FIG. 12C illustrates syntax structures for a type element.

FIG. 13 illustrates MIMEType sub-element of a video element.

FIG. 14 illustrates MIMEType sub-element of an audio element.

FIG. 15A illustrates MIMEType processes.

FIG. 15B illustrates MIMEType processes.

FIG. 16A illustrates a media extension syntax.

FIG. 16B illustrates a media extension syntax.

FIG. 17 illustrates a closed captioning syntax.

FIG. 18A illustrates a media extension syntax.

FIG. 18B illustrates a media extension syntax.

FIG. 18C illustrates a media extension syntax.

### DESCRIPTION OF EMBODIMENTS

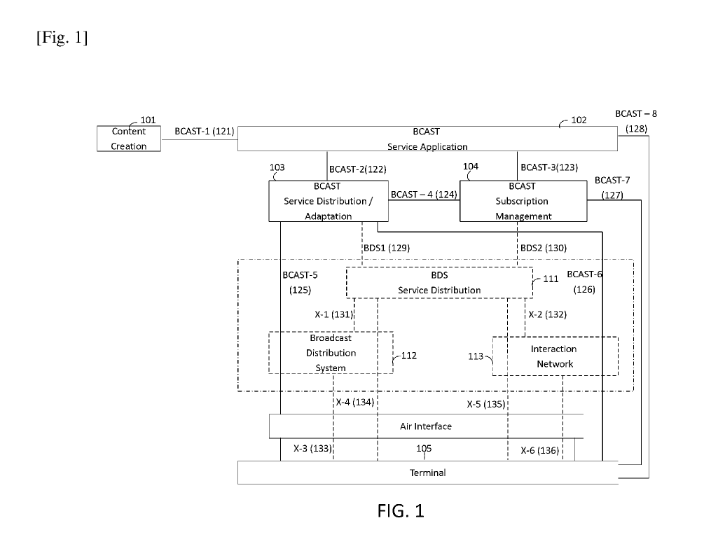

Referring to FIG. 1, a logical architecture of a broadcast system specified by OMA (Open Mobile Alliance) BCAST may include an application layer and a transport layer. The logical architecture of the BCAST system may include a Content Creation (CC) 101, a BCAST Service Application 102, a BCAST Service Distribution/Adaptation (BSDA) 103, a BCAST Subscription Management (BSM) 104, a Terminal 105, a Broadcast Distribution System (BDS) Service Distribution 111, a BDS 112, and an Interaction Network 113. It is to be understood that the broadcast system and/or receiver system may be reconfigured, as desired. It is to be understood that the broadcast system and/or receiver system may include additional elements and/or fewer elements, as desired.

In general, the Content Creation (CC) 101 may provide content that is the basis of BCAST services. The content may include files for common broadcast services, e.g., data for a movie including audio and video. The Content Creation 101 provides a BCAST Service Application 102 with attributes for the content, which are used to create a service guide and to determine a transmission bearer over which the services will be delivered.

In general, the BCAST Service Application 102 may receive data for BCAST services provided from the Content Creation 101, and converts the received data into a form suitable for providing media encoding, content protection, interactive services, etc. The BCAST Service Application 102 provides the attributes for the content, which is received from the Content Creation 101, to the BSDA 103 and the BSM 104.

In general, the BSDA 103 may perform operations, such as file/streaming delivery, service gathering, service protection, service guide creation/delivery and service notification, using the BCAST service data provided from the BCAST Service Application 102. The BSDA 103 adapts the services to the BDS 112.

In general, the BSM 104 may manage, via hardware or software, service provisioning, such as subscription and charging-related functions for BCAST service users, information provisioning used for BCAST services, and mobile terminals that receive the BCAST services.

In general, the Terminal 105 may receive content/service guide and program support information, such as content protection, and provides a broadcast service to a user. The BDS Service Distribution 111 delivers mobile broadcast services to a plurality of terminals through mutual communication with the BDS 112 and the Interaction Network 113.

In general, the BDS 112 may deliver mobile broadcast services over a broadcast channel, and may include, for example, a Multimedia Broadcast Multicast Service (MBMS) by 3rd Generation Project Partnership (3GPP), a Broadcast Multicast Service (BCMCS) by 3rd Generation Project Partnership 2 (3GPP2), a DVB-Handheld (DVB-H) by Digital Video Broadcasting (DVB), or an Internet Protocol (IP) based broadcasting communication network. The Interaction Network 113 provides an interaction channel, and may include, for example, a cellular network.

The reference points, or connection paths between the logical entities of FIG. 1, may have a plurality of interfaces, as desired. The interfaces are used for communication between two or more logical entities for their specific purposes. A message format, a protocol and the like are applied for the interfaces. In some embodiments, there are no logical interfaces between one or more different functions.

BCAST-1 121 is a transmission path for content and content attributes, and BCAST-2 122 is a transmission path for a content-protected or content-unprotected BCAST service, attributes of the BCAST service, and content attributes.

BCAST-3 123 is a transmission path for attributes of a BCAST service, attributes of content, user preference/subscription information, a user request, and a response to the request. BCAST-4 124 is a transmission path for a notification message, attributes used for a service guide, and a key used for content protection and service protection.

BCAST-5 125 is a transmission path for a protected BCAST service, an unprotected BCAST service, a content-protected BCAST service, a content-unprotected BCAST service, BCAST service attributes, content attributes, a notification, a service guide, security materials such as a Digital Right Management (DRM) Right Object (RO) and key values used for BCAST service protection, and all data and signaling transmitted through a broadcast channel.

BCAST-6 126 is a transmission path for a protected BCAST service, an unprotected BCAST service, a content-protected BCAST service, a content-unprotected BCAST service, BCAST service attributes, content attributes, a notification, a service guide, security materials such as a DRM RO and key values used for BCAST service protection, and all data and signaling transmitted through an interaction channel.

BCAST-7 127 is a transmission path for service provisioning, subscription information, device management, and user preference information transmitted through an interaction channel for control information related to receipt of security materials, such as a DRM RO and key values used for BCAST service protection.

BCAST-8 128 is a transmission path through which user data for a BCAST service is provided. BDS-1 129 is a transmission path for a protected BCAST service, an unprotected BCAST service, BCAST service attributes, content attributes, a notification, a service guide, and security materials, such as a DRM RO and key values used for BCAST service protection.

BDS-2 130 is a transmission path for service provisioning, subscription information, device management, and security materials, such as a DRM RO and key values used for BCAST service protection.

X-1 131 is a reference point between the BDS Service Distribution 111 and the BDS 112. X-2 132 is a reference point between the BDS Service Distribution 111 and the Interaction Network 113. X-3 133 is a reference point between the BDS 112 and the Terminal 105. X-4 134 is a reference point between the BDS Service Distribution 111 and the Terminal 105 over a broadcast channel. X-5 135 is a reference point between the BDS Service Distribution 111 and the Terminal 105 over an interaction channel. X-6 136 is a reference point between the Interaction Network 113 and the Terminal 105.

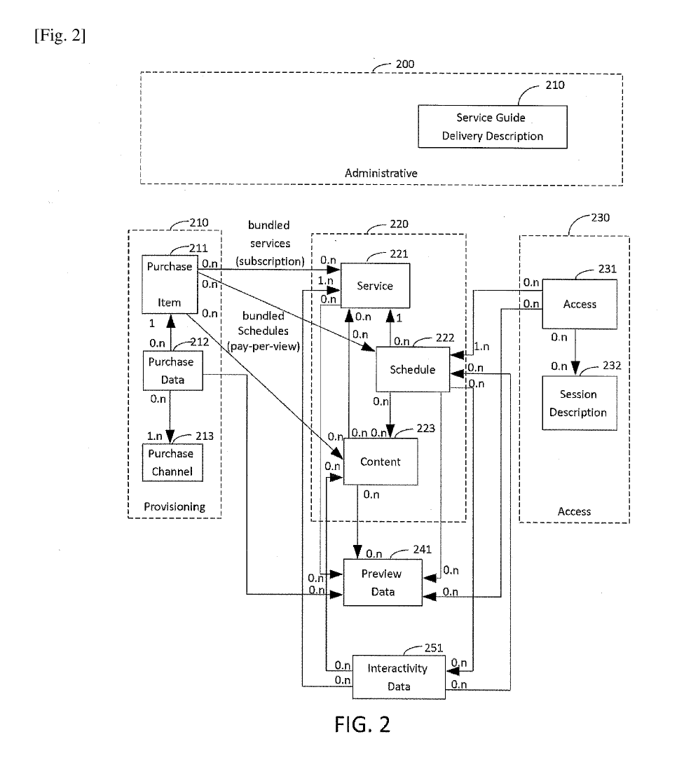

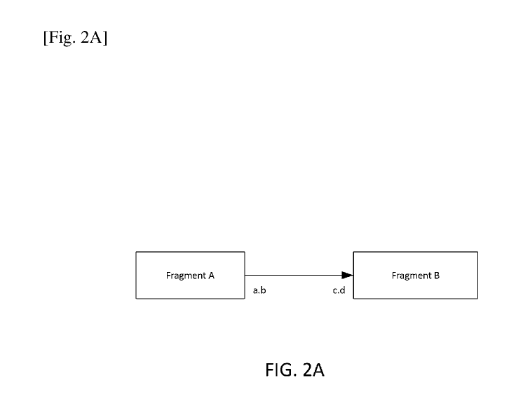

Referring to FIG. 2, an exemplary service guide for the OMA BCAST system is illustrated. For purposes of illustration, the solid arrows between fragments indicate the reference directions between the fragments. It is to be understood that the service guide system may be reconfigured, as desired. It is to be understood that the service guide system may include additional elements and/or fewer elements, as desired. It is to be understood that functionality of the elements may be modified and/or combined, as desired.

FIG. 2A is a diagram showing cardinalities and reference direction between service guide fragments. The meaning of the cardinalities shown in the FIG. 2 is the following: One instantiation of Fragment A as in FIG. 2A references c to d instantiations of Fragment B. If c=d, d is omitted. Thus, if c>0 and Fragment A exists, at least c instantiation of Fragment B must also exist, but at most d instantiations of Fragment B may exist. Vice versa, one instantiation of Fragment B is referenced by a to b instantiations of Fragment A. If a=b, b is omitted. The arrow connection from Fragment A pointing to Fragment B indicates that Fragment A contains the reference to Fragment B.

With respect to FIG. 2, in general, the service guide may include an Administrative Group 200 for providing basic information about the entire service guide, a Provisioning Group 210 for providing subscription and purchase information, a Core Group 220 that acts as a core part of the service guide, and an Access Group 230 for providing access information that control access to services and content.

The Administrative Group 200 may include a Service Guide Delivery Descriptor (SGDD) block 201. The Provision Group 210 may include a Purchase Item block 211, a Purchase Data block 212, and a Purchase Channel block 213. The Core Group 220 may include a Service block 221, a Schedule block 222, and a Content block 223. The Access Group 230 may include an Access block 231 and a Session Description block 232.

The service guide may further include Preview Data 241 and Interactivity Data 251 in addition to the four information groups 200, 210, 220, and 230.

The aforementioned components may be referred to as basic units or fragments constituting aspects of the service guide, for purposes of identification.

The SGDD fragment 201 may provide information about a delivery session where a Service Guide Delivery Unit (SGDU) is located. The SGDU is a container that contains service guide fragments 211, 212, 213, 221, 222, 223, 231, 232, 241, and 251, which constitute the service guide. The SGDD may also provide the information on the entry points for receiving the grouping information and notification messages.

The Service fragment 221, which is an upper aggregate of the content included in the broadcast service, may include information on service content, genre, service location, etc. In general, the ‘Service’ fragment describes at an aggregate level the content items which comprise a broadcast service. The service may be delivered to the user using multiple means of access, for example, the broadcast channel and the interactive channel. The service may be targeted at a certain user group or geographical area. Depending on the type of the service it may have interactive part(s), broadcast-only part(s), or both. Further, the service may include components not directly related to the content but to the functionality of the service such as purchasing or subscription information. As the part of the Service Guide, the ‘Service’ fragment forms a central hub referenced by the other fragments including ‘Access’, ‘Schedule’, ‘Content’ and ‘Purchaseltem’ fragments. In addition to that, the ‘Service’ fragment may reference ‘PreviewData’ fragment. It may be referenced by none or several of each of these fragments. Together with the associated fragments the terminal may determine the details associated with the service at any point of time. These details may be summarized into a user-friendly display, for example, of what, how and when the associated content may be consumed and at what cost.

The Access fragment 231 may provide access-related information for allowing the user to view the service and delivery method, and session information associated with the corresponding access session. As such, the ‘Access’ fragment describes how the service may be accessed during the lifespan of the service. This fragment contains or references Session Description information and indicates the delivery method. One or more ‘Access’ fragments may reference a ‘Service’ fragment, offering alternative ways for accessing or interacting with the associated service. For the Terminal, the ‘Access’ fragment provides information on what capabilities are required from the terminal to receive and render the service. The ‘Access’ fragment provides Session Description parameters either in the form of inline text, or through a pointer in the form of a URI to a separate Session Description. Session Description information may be delivered over either the broadcast channel or the interaction channel.

The Session Description fragment 232 may be included in the Access fragment 231, and may provide location information in a Uniform Resource Identifier (URI) form so that the terminal may detect information on the Session Description fragment 232. The Session Description fragment 232 may provide address information, codec information, etc., about multimedia content existing in the session. As such, the ‘SessionDescription’ is a Service Guide fragment which provides the session information for access to a service or content item. Further, the Session Description may provide auxiliary description information, used for associated delivery procedures. The Session Description information is provided using either syntax of SDP in text format, or through a 3GPP MBMS User Service Bundle Description [3GPP TS 26.346] (USBD). Auxiliary description information is provided in XML format and contains an Associated Delivery Description as specified in [BCAST10-Distribution]. Note that in case SDP syntax is used, an alternative way to deliver the Session Description is by encapsulating the SDP in text format in ‘Access’ fragment. Note that Session Description may be used both for Service Guide delivery itself as well as for the content sessions.

The Purchase Item fragment 211 may provide a bundle of service, content, time, etc., to help the user subscribe to or purchase the Purchase Item fragment 211. As such, the ‘PurchaseItem’ fragment represents a group of one or more services (i.e. a service bundle) or one or more content items, offered to the end user for free, for subscription and/or purchase. This fragment can be referenced by ‘PurchaseData’ fragment(s) offering more information on different service bundles. The ‘PurchaseItem’ fragment may be also associated with: (1) a ‘Service’ fragment to enable bundled services subscription and/or, (2) a ‘Schedule’ fragment to enable consuming a certain service or content in a certain timeframe (pay-per-view functionality) and/or, (3) a ‘Content’ fragment to enable purchasing a single content file related to a service, (4) other ‘PurchaseItem’ fragments to enable bundling of purchase items.

The Purchase Data fragment 212 may include detailed purchase and subscription information, such as price information and promotion information, for the service or content bundle. The Purchase Channel fragment 213 may provide access information for subscription or purchase. As such, the main function of the ‘PurchaseData’ fragment is to express all the available pricing information about the associated purchase item. The ‘PurchaseData’ fragment collects the information about one or several purchase channels and may be associated with PreviewData specific to a certain service or service bundle. It carries information about pricing of a service, a service bundle, or, a content item. Also, information about promotional activities may be included in this fragment. The SGDD may also provide information regarding entry points for receiving the service guide and grouping information about the SGDU as the container.

The Preview Data fragment 241 may be used to provide preview information for a service, schedule, and content. As such, ‘PreviewData’ fragment contains information that is used by the terminal to present the service or content outline to users, so that the users can have a general idea of what the service or content is about. ‘PreviewData’ fragment can include simple texts, static images (for example, logo), short video clips, or even reference to another service which could be a low bit rate version for the main service. ‘Service’, ‘Content’, ‘PurchaseData’, ‘Access’ and ‘Schedule’ fragments may reference ‘PreviewData’ fragment.

The Interactivity Data fragment 251 may be used to provide an interactive service according to the service, schedule, and content during broadcasting. More detailed information about the service guide can be defined by one or more elements and attributes of the system. As such, the InteractivityData contains information that is used by the terminal to offer interactive services to the user, which is associated with the broadcast content. These interactive services enable users to e.g. vote during TV shows or to obtain content related to the broadcast content. ‘InteractivityData’ fragment points to one or many ‘InteractivityMedia’ documents that include xhtml files, static images, email template, SMS template, MMS template documents, etc. The ‘InteractivityData’ fragment may reference the ‘Service’, ‘Content’ and ‘Schedule’ fragments, and may be referenced by the ‘Schedule’ fragment.

The ‘Schedule’ fragment defines the timeframes in which associated content items are available for streaming, downloading and/or rendering. This fragment references the ‘Service’ fragment. If it also references one or more ‘Content’ fragments or ‘InterativityData’ fragments, then it defines the valid distribution and/or presentation timeframe of those content items belonging to the service, or the valid distribution timeframe and the automatic activation time of the InteractivityMediaDocuments associated with the service. On the other hand, if the ‘Schedule’ fragment does not reference any ‘Content’ fragment(s) or ‘InteractivityData’ fragment(s), then it defines the timeframe of the service availability which is unbounded.

The ‘Content’ fragment gives a detailed description of a specific content item. In addition to defining a type, description and language of the content, it may provide information about the targeted user group or geographical area, as well as genre and parental rating. The ‘Content’ fragment may be referenced by Schedule, PurchaseItem or ‘InteractivityData’ fragment. It may reference ‘PreviewData’ fragment or ‘Service’ fragment.

The ‘PurchaseChannel’ fragment carries the information about the entity from which purchase of access and/or content rights for a certain service, service bundle or content item may be obtained, as defined in the ‘PurchaseData’ fragment. The purchase channel is associated with one or more Broadcast Subscription Managements (BSMs). The terminal is only permitted to access a particular purchase channel if it is affiliated with a BSM that is also associated with that purchase channel. Multiple purchase channels may be associated to one ‘PurchaseData’ fragment. A certain end-user can have a “preferred” purchase channel (e.g. his/her mobile operator) to which all purchase requests should be directed. The preferred purchase channel may even be the only channel that an end-user is allowed to use.

The ServiceGuideDeliveryDescriptor is transported on the Service Guide Announcement Channel, and informs the terminal the availability, metadata and grouping of the fragments of the Service Guide in the Service Guide discovery process. A SGDD allows quick identification of the Service Guide fragments that are either cached in the terminal or being transmitted. For that reason, the SGDD is preferably repeated if distributed over broadcast channel. The SGDD also provides the grouping of related Service Guide fragments and thus a means to determine completeness of such group. The ServiceGuideDeliveryDescriptor is especially useful if the terminal moves from one service coverage area to another. In this case, the ServiceGuideDeliveryDescriptor can be used to quickly check which of the Service Guide fragments that have been received in the previous service coverage area are still valid in the current service coverage area, and therefore don't have to be re-parsed and re-processed.

Although not expressly depicted, the fragments that constitute the service guide may include element and attribute values for fulfilling their purposes. In addition, one or more of the fragments of the service guide may be omitted, as desired. Also, one or more fragments of the service guide may be combined, as desired. Also, different aspects of one or more fragments of the service guide may be combined together, reorganized, and otherwise modified, or constrained as desired.

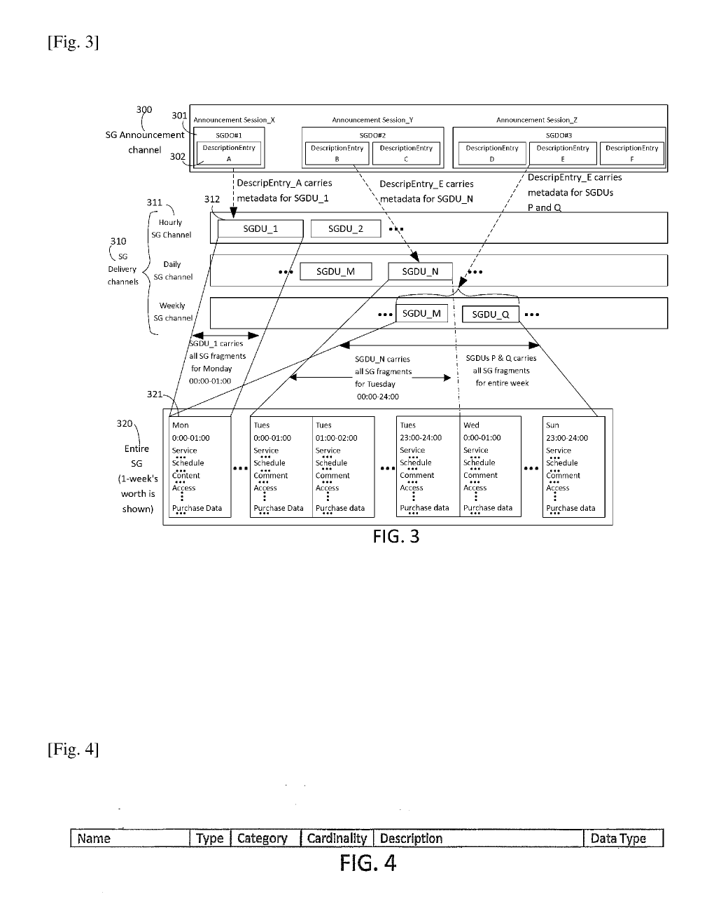

Referring to FIG. 3, an exemplary block diagram illustrates aspects of a service guide delivery technique. The Service Guide Deliver Descriptor fragment 201 may include the session information, grouping information, and notification message access information related to all fragments containing service information. When the mobile broadcast service-enabled terminal 105 turns on or begins to receive the service guide, it may access a Service Guide Announcement Channel (SG Announcement Channel) 300.

The SG Announcement Channel 300 may include at least one of SGDD 200 (e.g., SGDD #1, . . . , SGDD #2, SGDD #3), which may be formatted in any suitable format, such as that illustrated in Service Guide for Mobile Broadcast Services, Open Mobile Alliance, Version 1.0.1, Jan. 9, 2013 and/or Service Guide for Mobile Broadcast Services, open Mobile Alliance, Version 1.1, Oct. 29, 3013; both of which are incorporated by reference in their entirety. The descriptions of elements and attributes constituting the Service Guide Delivery Descriptor fragment 201 may be reflected in any suitable format, such as for example, a table format and/or in an eXtensible Markup Language (XML) schema.

The actual data is preferably provided in XML format according to the SGDD fragment 201. The information related to the service guide may be provided in various data formats, such as binary, where the elements and attributes are set to corresponding values, depending on the broadcast system.

The terminal 105 may acquire transport information about a Service Guide Delivery Unit (SGDU) 312 containing fragment information from a DescriptorEntry of the SGDD fragment received on the SG Announcement Channel 300.

The DescriptorEntry 302, which may provide the grouping information of a Service Guide includes the “GroupingCriteria”, “ServiceGuideDeliveryUnit”, “Transport”, and AlternativeAccessURI”. The transport-related channel information may be provided by the “Transport” or “AlternativeAccessURI”, and the actual value of the corresponding channel is provided by “ServiceGuideDeliveryUnit”. Also, upper layer group information about the SGDU 312, such as “Service” and “Genre”, may be provided by “GroupingCriteria”. The terminal 105 may receive and present all of the SGDUs 312 to the user according to the corresponding group information.

Once the transport information is acquired, the terminal 105 may access all of the Delivery Channels acquired from a DescriptorEntry 302 in an SGDD 301 on an SG Delivery Channel 310 to receive the actual SGDU 312. The SG Delivery Channels can be identified using the “GroupingCriteria”. In the case of time grouping, the SGDU can be transported with a time-based transport channel such as an Hourly SG Channel 311 and a Daily SG Channel. Accordingly, the terminal 105 can selectively access the channels and receive all the SGDUs existing on the corresponding channels. Once the entire SGDU is completely received on the SG Delivery Channels 310, the terminal 105 checks all the fragments contained in the SGDUs received on the SG Delivery Channels 310 and assembles the fragments to display an actual full service guide 320 on the screen which can be subdivided on an hourly basis 321.

In the conventional mobile broadcast system, the service guide is formatted and transmitted such that only configured terminals receive the broadcast signals of the corresponding broadcast system. For example, the service guide information transmitted by a DVB-H system can only be received by terminals configured to receive the DVB-H broadcast.

The service providers provide bundled and integrated services using various transmission systems as well as various broadcast systems in accordance with service convergence, which may be referred to as multiplay services. The broadcast service providers may also provide broadcast services on IP networks. Integrated service guide transmission/reception systems may be described using terms of entities defined in the 3GPP standards and OMA BCAST standards (e.g., a scheme). However, the service guide/reception systems may be used with any suitable communication and/or broadcast system.

Referring to FIG. 4, the scheme may include, for example, (1) Name; (2) Type; (3) Category; (4) Cardinality; (5) Description; and (6) Data type. The scheme may be arranged in any manner, such as a table format of an XML format.

The “name” column indicates the name of an element or an attribute. The “type” column indicates an index representing an element or an attribute. An element can be one of E1, E2, E3, E4, . . . , E[n]. E1 indicates an upper element of an entire message, E2 indicates an element below the E1, E3 indicates an element below E2, E4 indicates an element below the E3, and so forth. An attribute is indicated by A. For example, an “A” below E1 means an attribute of element E1. In some cases the notation may mean the following E=Element, A=Attribute, E1=sub-element, E2=sub-element's sub-element, E[n]=sub-element of element[n−1]. The “category” column is used to indicate whether the element or attribute is mandatory. If an element is mandatory, the category of the element is flagged with an “M”. If an element is optional, the category of the element is flagged with an “O”. If the element is optional for network to support it the element is flagged with a “NO”. If the element is mandatory for terminal to support it is flagged with a TM. If the element is mandatory for network to support it the element is flagged with “NM”. If the element is optional for terminal to support it the element is flagged with “TO”. If an element or attribute has cardinality greater than zero, it is classified as M or NM to maintain consistency. The “cardinality” column indicates a relationship between elements and is set to a value of 0, 0 . . . 1, 1, 0 . . . n, and 1 . . . n. 0 indicates an option, 1 indicates a necessary relationship, and n indicates multiple values. For example, 0 . . . n means that a corresponding element can have no or n values. The “description” column describes the meaning of the corresponding element or attribute, and the “data type” column indicates the data type of the corresponding element or attribute.

A service may represent a bundle of content items, which forms a logical group to the end-user. An example would be a TV channel, composed of several TV shows. A ‘Service’ fragment contains the metadata describing the Mobile Broadcast service. It is possible that the same metadata (i.e., attributes and elements) exist in the ‘Content’ fragment(s) associated with that ‘Service’ fragment. In that situation, for the following elements: ‘ParentalRating’, ‘TargetUserProfile’, ‘Genre’ and ‘BroadcastArea’, the values defined in ‘Content’ fragment take precedence over those in ‘Service’ fragment.

The program guide elements of this fragment may be grouped between the Start of program guide and end of program guide cells in a fragment. This localization of the elements of the program guide reduces the computational complexity of the receiving device in arranging a programming guide. The program guide elements are generally used for user interpretation. This enables the content creator to provide user readable information about the service. The terminal should use all declared program guide elements in this fragment for presentation to the end-user. The terminal may offer search, sort, etc. functionalities. The Program Guide may consist of the following service elements: (1) Name; (2) Description; (3) AudioLanguage; (4) TextLanguage; (5) ParentalRating; (6) TargetUserProfile; and (7) Genre.

The “Name” element may refer to Name of the Service, possibly in multiple languages. The language may be expressed using built-in XML attribute ‘xml:lang’.

The “Description” element may be in multiple languages and may be expressed using built-in XML attribute ‘xml:lang’.

The “AudioLanguage” element may declare for the end users that this service is available with an audio track corresponding to the language represented by the value of this element. The textual value of this element can be made available for the end users in different languages. In such a case the language used to represent the value of this element may be signaled using the built-in XML attribute ‘xml:lang’, and may include multi-language support. The AudioLanguage may contain an attribute languageSDPTag.

The “languageSDPTag” attribute is an identifier of the audio language described by the parent ‘AudioLanguage’ element as used in the media sections describing the audio track in a Session Description. Each ‘AudioLanguage’ element declaring the same audio stream may have the same value of the ‘languageSDPTag’.

The “TextLanguage” element may declare for the end user that the textual components of this service are available in the language represented by the value of this element. The textual components can be, for instance, a caption or a sub-title track. The textual value of this element can be made available for the end users in different languages. In such a case the language used to represent the value of this element may be signaled using the built-in XML attribute ‘xml:lang’, and may include multi-language support. The same rules and constraints as specified for the element ‘AudioLanguage’ of assigning and interpreting the attributes ‘languageSDPTag’ and ‘xml:lang’ may be applied for this element.

The “languageSDPTag” attribute is an identifier of the text language described by the parent ‘TextLanguage’ element as used in the media sections describing the textual track in a Session Description.

The “ParentalRating” element may declare criteria parents and might be used to determine whether the associated item is suitable for access by children, defined according to the regulatory requirements of the service area. The terminal may support ‘ParentalRating’ being a free string, and the terminal may support the structured way to express the parental rating level by using the ‘ratingSystem’ and ‘ratingValueName’ attributes.

The “ratingSystem” attribute may specify the parental rating system in use, in which context the value of the ‘ParentalRating’ element is semantically defined. This allows terminals to identify the rating system in use in a non-ambiguous manner and act appropriately. This attribute may be instantiated when a rating system is used. Absence of this attribute means that no rating system is used (i.e. the value of the ‘ParentalRating’ element is to be interpreted as a free string).

The “ratingValueName” attribute may specify the human-readable name of the rating value given by this ParentalRating element.

The “TargetUserProfile” may specify elements of the users whom the service is targeting at. The detailed personal attribute names and the corresponding values are specified by attributes of ‘attributeName’ an ‘attributeValue’. Amongst the possible profile attribute names are age, gender, occupation, etc. (subject to national/local rules & regulations, if present and as applicable regarding use of personal profiling information and personal data privacy). The extensible list of ‘attributeName’ and ‘attributeValue’ pairs for a particular service enables end user profile filtering and end user preference filtering of broadcast services. The terminal may be able to support ‘TargetUserProfile’ element. The use of ‘TargetUserProfile’ element may be an “opt-in” capability for users. Terminal settings may allow users to configure whether to input their personal profile or preference and whether to allow broadcast service to be automatically filtered based on the users' personal attributes without users' request. This element may contain the following attributes: attributeName and attributeValue.

The “attributeName” attribute may be a profile attribute name.

The “attributeValue” attribute may be a profile attribute value.

The “Genre” element may specify classification of service associated with characteristic form (e.g. comedy, drama). The OMA BCAST Service Guide may allow describing the format of the Genre element in the Service Guide in two ways. The first way is to use a free string. The second way is to use the “href” attributes of the Genre element to convey the information in the form of a controlled vocabulary (classification scheme as defined in [TVA-Metadata] or classification list as defined in [MIGFG]). The built-in XML attribute xml:lang may be used with this element to express the language. The network may instantiate several different sets of ‘Genre’ element, using it as a free string or with a ‘href’ attribute. The network may ensure the different sets have equivalent and nonconflicting meaning, and the terminal may select one of the sets to interpret for the end-user. The ‘Genre’ element may contain the following attributes: type and href.

The “type” attribute may signal the level of the ‘Genre’ element, such as with the values of “main”, “second”, and “other”.

The “href” attribute may signal the controlled vocabulary used in the ‘Genre’ element.

After reviewing the set of programming guide elements and attributes; (1) Name; (2) Description; (3) AudioLanguage; (4) TextLanguage; (5) ParentalRating; (6) TargetUserProfile; and (7) Genre it was determined that the receiving device still may have insufficient information defined within the programming guide to appropriately render the information in a manner suitable for the viewer. In particular, the traditional NTSC television stations typically have numbers such as, 2, 4, 6, 8, 12, and 49. For digital services, program and system information protocol includes a virtual channel table that, for terrestrial broadcasting defines each digital television service with a two-part number consisting of a major channel followed by a minor channel. The major channel number is usually the same as the NTSC channel for the station, and the minor channels have numbers depending on how many digital television services are present in the digital television multiples, typically starting at 1. For example, the analog television channel 9, WUSA-TV in Washington, D.C., may identify its two overthe-air digital services as follows: channel 9-1 WUSA-DT and channel 9-2 9-Radar. This notation for television channels is readily understandable by a viewer, and the programming guide elements may include this capability as an extension to the programming guide so that the information may be computationally efficiently processed by the receiving device and rendered to the viewer.

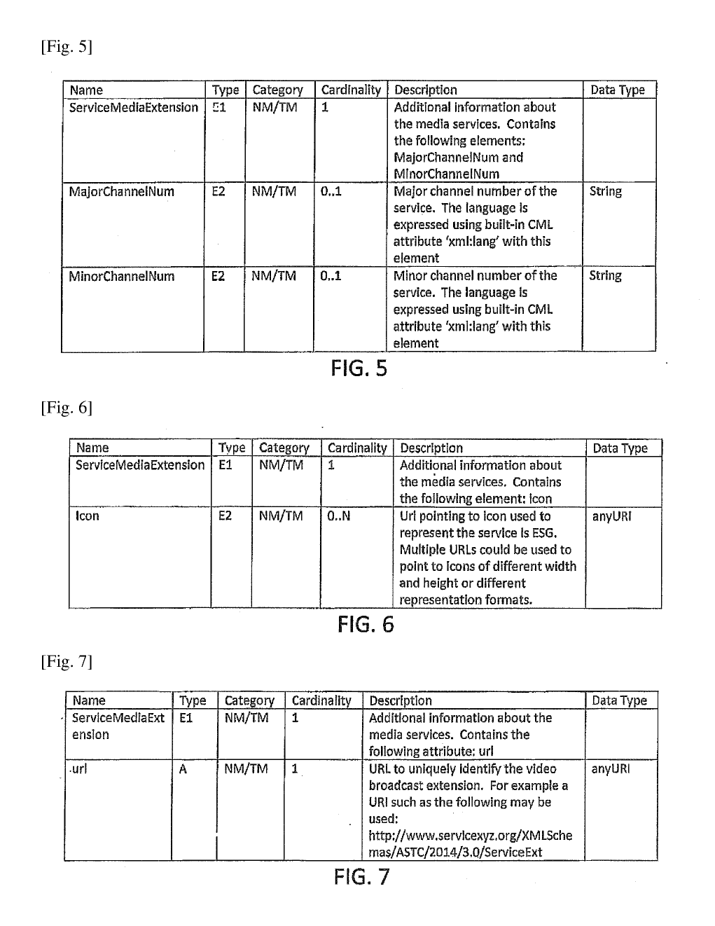

Referring to FIG. 5, to facilitate this flexibility an extension, such as ServiceMediaExtension, may be included with the programming guide elements which may specify further services. In particular, the ServiceMediaExtension may have a type element E1, a category NM/TM, with a cardinality of 1. The major channel may be referred to as MajorChannelNum, with a type element E2, a category NM/TM, a cardinality of 0..1, and a data type of string. By including the data type of string, rather than an unsignedByte, permits the support of other languages which may not necessarily be a number. The program guide information, including the ServiceMediaExtension may be included in any suitable broadcasting system, such as for example, ATSC.

After further reviewing the set of programming guide elements and attributes; (1) Name; (2) Description; (3) AudioLanguage; (4) TextLanguage; (5) ParentalRating; (6) TargetUserProfile; and (7) Genre it was determined that the receiving device still may have insufficient information suitable to appropriately rendering the information in a manner suitable for the viewer. In many cases, the viewer associates a graphical icon with a particular program and/or channel and/or service. In this manner, the graphical icon should be selectable by the system, rather than being non-selectable.

Referring to FIG. 6, to facilitate this flexibility an extension may be included with the programming guide elements which may specify an icon.

After yet further reviewing the set of programming guide elements and attributes; (1) Name; (2) Description; (3) AudioLanguage; (4) TextLanguage; (5) ParentalRating; (6) TargetUserProfile; and (7) Genre it was determined that the receiving device still may have insufficient information suitable to appropriately rendering the information in a manner suitable for the viewer. In many cases, the viewer may seek to identify the particular extension being identified using the same extension elements. In this manner, a url may be used to specifically identify the particular description of the elements of the extension. In this manner, the elements of the extension may be modified in a suitable manner without having to expressly describe multiple different extensions.

Referring to FIG. 7, to facilitate this flexibility an extension may be included with the programming guide elements which may specify a url.

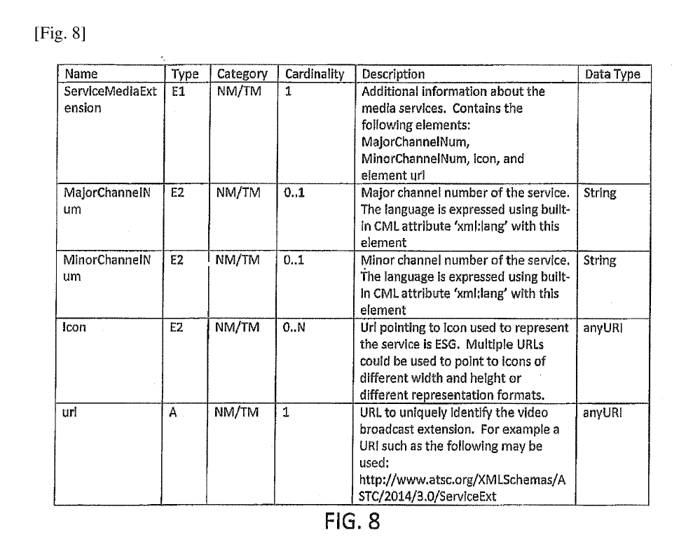

Referring to FIG. 8, to facilitate this overall extension flexibility an extension may be included with the programming guide elements which may specify an icon, major channel number, minor channel number, and/or url.

In other embodiments, instead of using Data Type “string” for MajorChannelNum and MinorChannelNum elements, other data types may be used. For example, the data type unsignedInt may be used. In another example, a string of limited length may be used, e.g. string of 10 digits. An exemplary XML schema syntax for the above extensions is illustrated below.

```
<xs:element name=“ServiceMediaExtension ” type=“SerExtensionType”
minOccurs=“0” maxOccurs=“unbounded”/>
<xs:complexType name=“SerExtensionType”>
      <xs:sequence>
            <xs:element name=“Icon” type=“xs:anyURI” minOccurs=“0”
            maxOccurs=“unbounded”/>
            <xs:element name=“MajorChannelNum” type=“LanguageString”
            minOccurs=“0” maxOccurs=“1”/>
            <xs:element name=“MinorChannelNum” type=“LanguageString”
            minOccurs=“0” maxOccurs=“1”/>
      </xs:sequence>
      <xs:attribute name=“url” type=“xs:anyURI” use=“required”/>
</xs:complexType>
```

In some embodiments the ServiceMediaExtension may be included inside a OMA “extension” element or may in general use OMA extension mechanism for defining the ServiceMediaExtension.

In some embodiments the MajorChannelNum and MinorChannelNum may be combined into one common channel number and represented. For example a ChannelNum string may be created by concatenating MajorChannelNum followed by a period (‘.’) followed by MinorChannelNum. Other such combinations are also possible with period replaced by other characters. Similar concept can be applied when using unsignedInt or other data types to represent channel numbers in terms of combining MajorChannelNum and MinorChannelNum into one number representation.

In yet another embodiment a MajorChannelNum.MinorChannelNum could be represented as “ServiceId” element (Service Id) for the service.

In another embodiment, the ServiceMediaExtension shall only be used inside a PrivateExt element within a Service fragmentAn exemplary XML schema syntax for such an extension is illustrated below.

```
<element name=“ ServiceMediaExtension ” type=“ SerExtensionType ”>
          <annotation>
                <documentation>
```

This element is a wrapper for extensions to OMA BOAST SG Service fragments. It shall only be used inside a PrivateExt element within a Service fragment.

```
                </documentation>
              </annotation>
</element>
<xs:complexType name=“SerExtensionType”>
      <xs:sequence>
              <xs:element name=“Icon” type=“xs:anyURI” minOccurs=“0”
              maxOccurs=“unbounded”/>
              <xs:element name=“MajorChannelNum” type=“LanguageString”
              minOccurs=“0” maxOccurs=“1”/>
              <xs:element name=“MinorChannelNum” type=“LanguageString”
              minOccurs=“0” maxOccurs=“1”/>
      </xs:sequence>
      <xs:attribute name=“url” type=“xs:anyURI” use=“required”/>
</xs:complexType>
```

In other embodiments some of the elements above may be changed from E2 to E1. In other embodiments the cardinality of some of the elements may be changed. In addition, if desired, the category may be omitted since it is generally duplicative of the information included with the cardinality.

It is desirable to map selected components of the ATSC service elements and attributes to the OMA service guide service fragment program guide. For example, the “Description” attribute of the OMA service guide fragment program guide may be mapped to “Description” of the ATSC service elements and attributes, such as for example ATSC-Mobile DTV Standard, Part 4—Announcement, other similar broadcast or mobile standards for similar elements and attributes. For example, the “Genre” attribute of the OMA service guide fragment program guide may be mapped to “Genre” of the ATSC service elements and attributes, such as for example ATSC-Mobile DTV Standard, Part 4—Announcement, other similar standards for similar elements and attributes. In one embodiment Genre scheme as defined in Section 6.10.2 of ATSC A153/Part 4 may be utilized For example, the “Name” attribute of the OMA service guide fragment program guide may be mapped to “Name” of the ATSC service elements and attributes, such as for example ATSC-Mobile DTV Standard, Part 4—Announcement, other similar standards for similar elements and attributes. Preferably, the cardinality of the name is selected to be 0..N, which permits the omission of the name which reduces the overall bit rate of the system and increase flexibility. For example, the “ParentalRating” attribute of the OMA service guide fragment program guide may be mapped to a new “ContentAdvisory” of the ATSC service element and attributes, such as for example ATSC-Mobile DTV Standard, Part 4—Announcement, or similar standards for similar elements and attributes. For example, the “TargetUserProfile” attribute of the OMA service guide fragment program guide may be mapped to a new “Personalization” of the ATSC service element and attributes, such as for example ATSC-Mobile DTV Standard, Part 4—Announcement, or similar standards for similar elements and attributes.

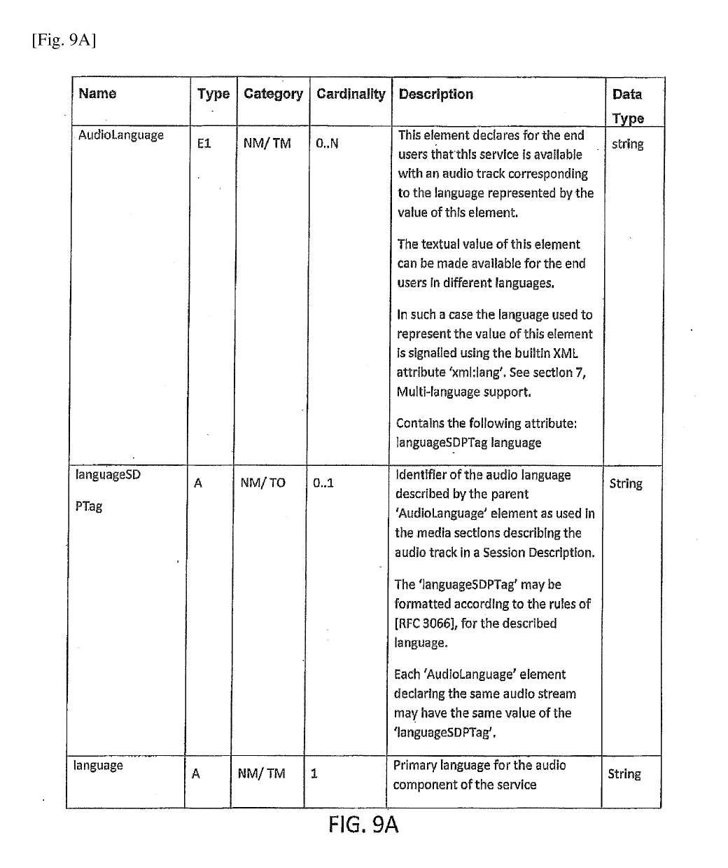

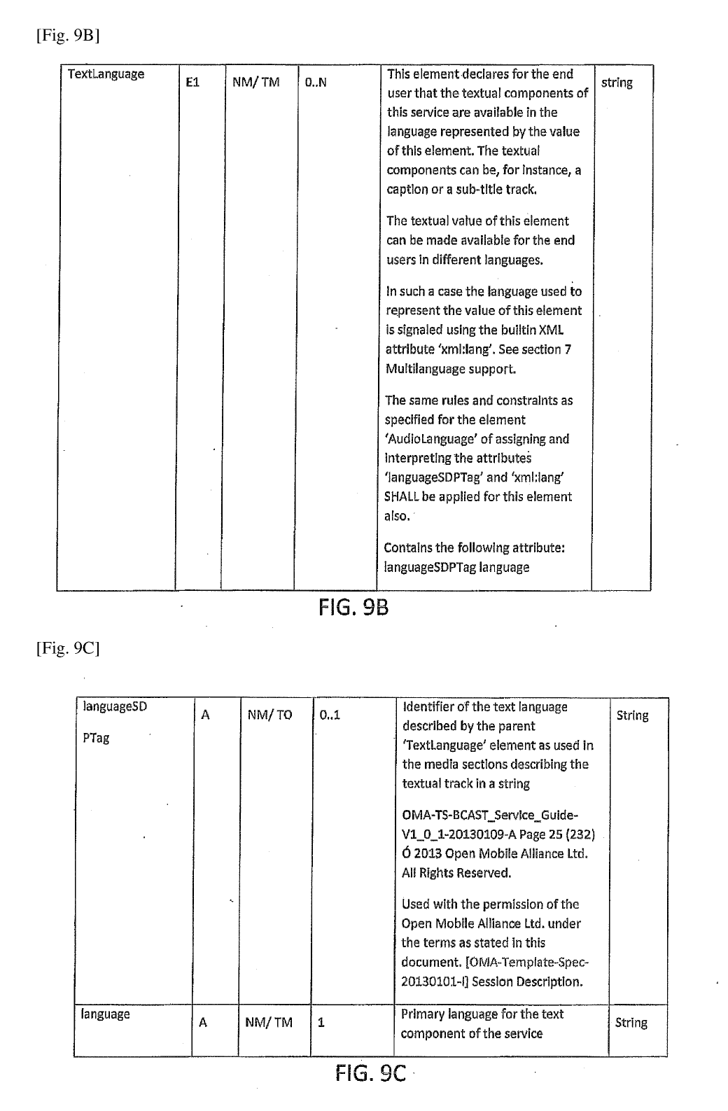

Referring to FIGS. 9A, 9B, 9C, the elements AudioLanguage (with attribute languageSDPTag) and TextLanguage (with attribute languageSDPTag) could be included if Session Description Fragment is included in the service announcement, such as for example ATSC-Mobile DTV Standard, Part 4—Announcement, or similar standards for similar elements and attributes. This is because the attribute languageSDPTag for the elements AudioLanguage and TextLanguage are preferably mandatory. This attribute provides identifier for audio/text language described by the parent element as used in the media sections describing audio/text track in a session description. In another embodiment the attribute languageSDPTag could be made optional and the elements AudioLanguage and TextLanguage could be included with an attribute “Langugage” with data type “string” which can provide language name.

An example XML schema syntax for this is shown below.

```
<xs:complexType name=“AudioOrTextLanguageType”>
      <xs:simpleContent>
            <xs:extension base=“LanguageString”>
                  <xs:attribute name=“languageSDPTag” type=“xs:string”
use=“optional”/>
                  <xs:attribute name=“language” type=“xs:string”
            use=“required”/>
            </xs:extension>
      </xs:simpleContent>
</xs:complexType>
```

In another embodiment the attributes languageSDPTag for the elements AudioLanguage and TextLanguage could be removed. An example XML schema syntax for this is shown below.

```
<xs:complexType name=“AudioOrTextLanguageType”>
      <xs:simpleContent>
            <xs:extension base=“LanguageString”>
                  <xs:attribute name=“language” type=“xs:string”
            use=“required”/>
            </xs:extension>
      </xs:simpleContent>
</xs:complexType>
```

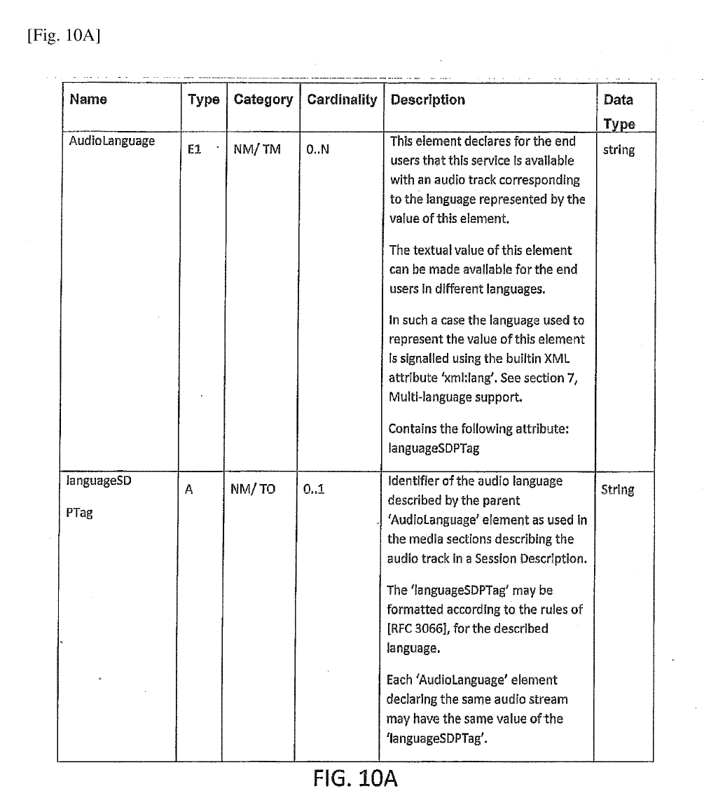

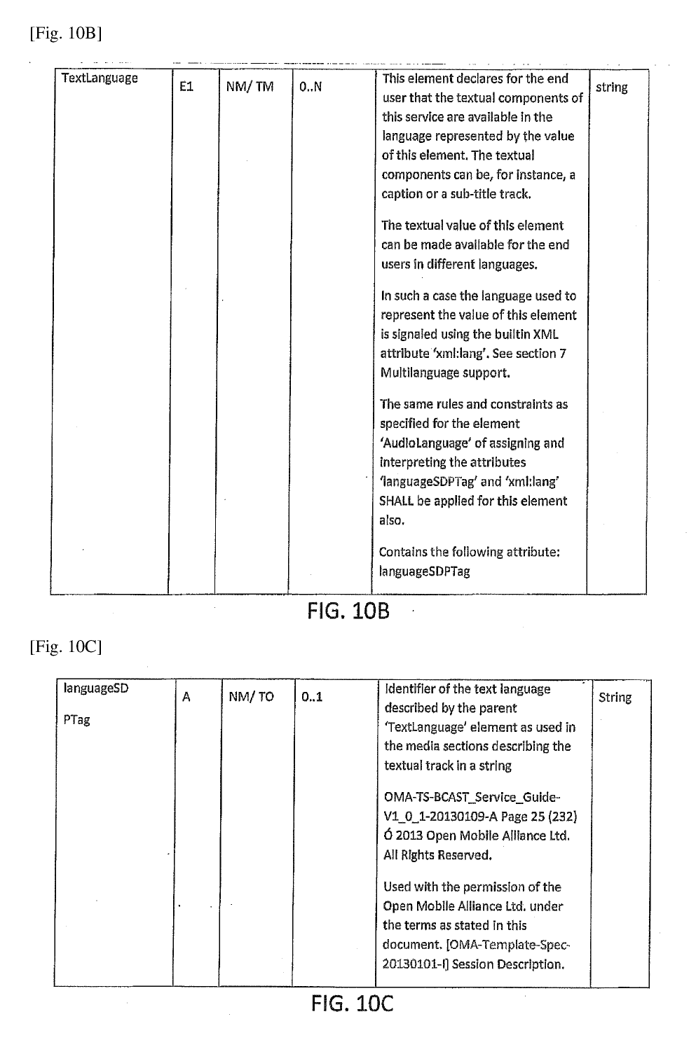

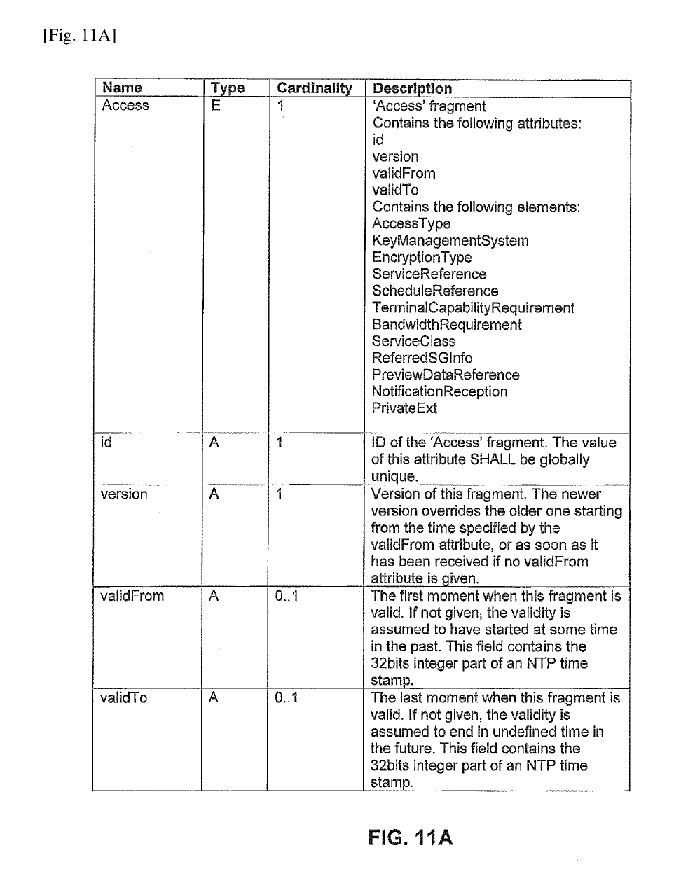

Referring to FIGS. 10A, 10B, 10C, the elements AudioLanguage (with attribute languageSDPTag) and TextLanguage (with attribute languageSDPTag) could be included if Session Description Fragment is included in the service announcement, such as for example ATSC-Mobile DTV Standard, Part 4—Announcement, or similar standards for similar elements and attributes. This is because the attribute languageSDPTag for the elements AudioLanguage and TextLanguage are preferably mandatory. This attribute provides identifier for audio/text language described by the parent element as used in the media sections describing audio/text track in a session description. In another embodiment the attribute languageSDPTag could be made optional.

An example XML schema syntax for this is shown below.

```
<xs:complexType name=“AudioOrTextLanguageType”>
      <xs:simpleContent>
            <xs:extension base=“LanguageString”>
                  <xs:attribute name=“languageSDPTag” type=“xs:string”
use= “optional”/>
            </xs:extension>
      </xs:simpleContent>
</xs:complexType>
```

In another embodiment the attributes languageSDPTag for the elements AudioLanguage and TextLanguage could be removed. An example XML schema syntax for this is shown below.

```
<xs:complexType name=“AudioOrTextLanguageType”>
      <xs:simpleContent>
            <xs:extension base=“LanguageString”>
            </xs:extension>
      </xs:simpleContent>
</xs:complexType>
```

In another embodiment the attribute “language” could be mapped to ATSC service “language” element and could refer to the primary language of the service.

In another embodiment the value of element “AudioLanguage” could be mapped to ATSC service “language” element and could refer to the primary language of the audio servicein ATSC.

In another embodiment the value of element “TextLanguage” could be mapped to ATSC service “language” element and could refer to the primary language of the text service in ATSC. In some cases the text service may be a service such as closed caption service. In another embodiment the elements AudioLanguage and TextLanguage and their attributes could be removed.

In some embodiments, the service of the type Linear Service: On-Demand component may be forbidden. In that case, no ServiceType value may be assigned for that type of service.

As described, the ‘Access’ fragment describes how the service may be accessed during the lifespan of the service. This fragment may contain or reference Session Description information and indicates the delivery method. One or more ‘Access’ fragments may reference a ‘Service’ fragment, offering alternative ways for accessing or interacting with the associated service. For the Terminal/receiver, the ‘Access’ fragment provides information on what capabilities are required from the terminal to receive and render the service. The ‘Access’ fragment may provide Session Description parameters either in the form of inline text, or through a pointer in the form of a URI to a separate Session Description. Session Description information may be delivered over either the broadcast channel or the interaction channel.

The Access fragment 231 may provide access-related information for allowing the user to view the service and delivery method, and session information associated with the corresponding access session. Preferably the access fragment includes attributes particularly suitable for the access fragment, while excluding other attributes not particularly suitable for the access fragment. The same content using different codecs can be consumed by the terminals with different audio-video codec capabilities using different channels. For example, the video streaming program may be in two different formats, such as MPEG-2 and ATSC, where MPEG-2 is a low quality video stream and ATSC is a high quality video stream. A service fragment may be provided for the video streaming program to indicate that it is encoded in two different formats, namely, MPEG-2 and ATSC. Two access fragments may be provided, associated with the service fragment, to respectively specify the two access channels for the two video stream formats. The user may select the preferred access channel based upon the terminal's decoding capabilities, such as that specified by a terminal capabilities requirement element.

Indicating capability required to access the service in the service guide can help the receiver provide a better user experience of the service. For example in one case the receiver may grey out content from the service for which the corresponding access fragment indicates a terminal/receiver requirement which the receiver does not support. For example if the access fragment indicates that the service is offered in codec of the format XYZ only and if the receiver does not support the codec of the format XYZ then receiver may grey out the service and/or content for that service when showing the service guide. Alternatively instead of greying out the content in this case the receiver may not display the particular content when showing the service guide. This can result in better user experience because user does not see a content in the service guide only to select it and learn that it can not access it because it does not have the required codec to access the service.

The service fragment and the access fragment may be used to support the selective viewing of different versions (for example, basic version only contains audio; normal version contains both audio and video; or the basic version contains the low bit rate stream of the live show, but the normal version contains the high bit rate stream of the same live show) of the same real-time program with different requirements. The selective viewing provides more flexibility to the terminal/receiver users and ensures the users can consume their interested program even as the terminal/receiver is under a bad reception condition, and consequently enhances the user experience. A service fragment may be provided for the streaming program. Two access fragments may be provided, associated with the service fragment, to respectively specify the two access channels, one access fragment only delivers the basic version which only contains the audio component or contains the low bit rate streams of the original audio and video streams, another access fragment delivers the normal version which contains the original high rate streams of the audio and video streams.

The service fragment and the access fragment may be used to similarly distinguish between two different programs, each of which has a different language.

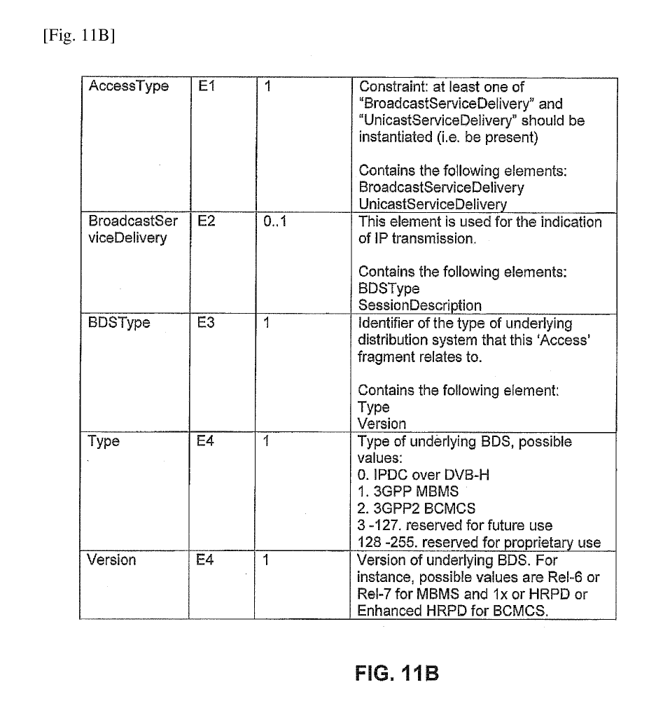

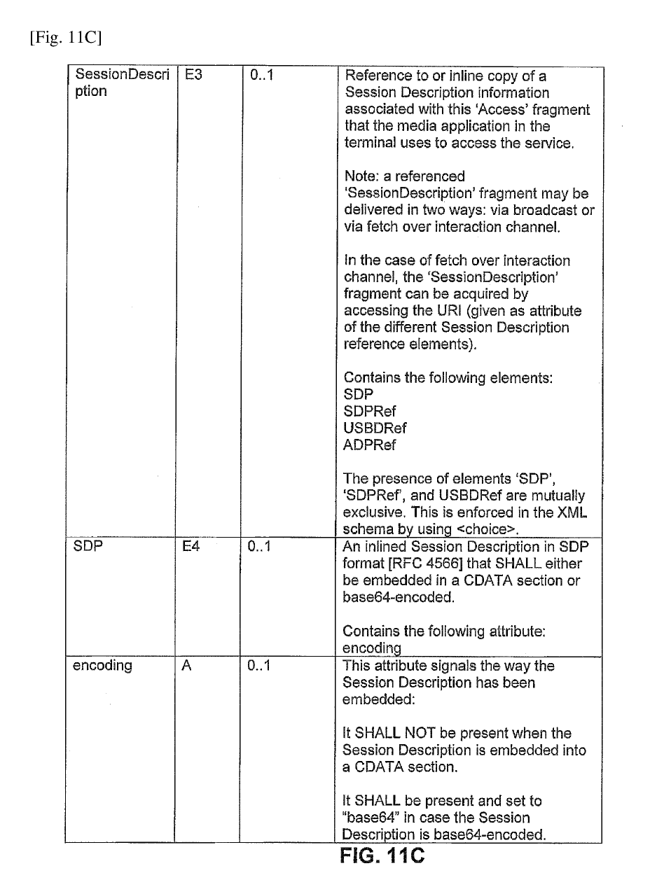

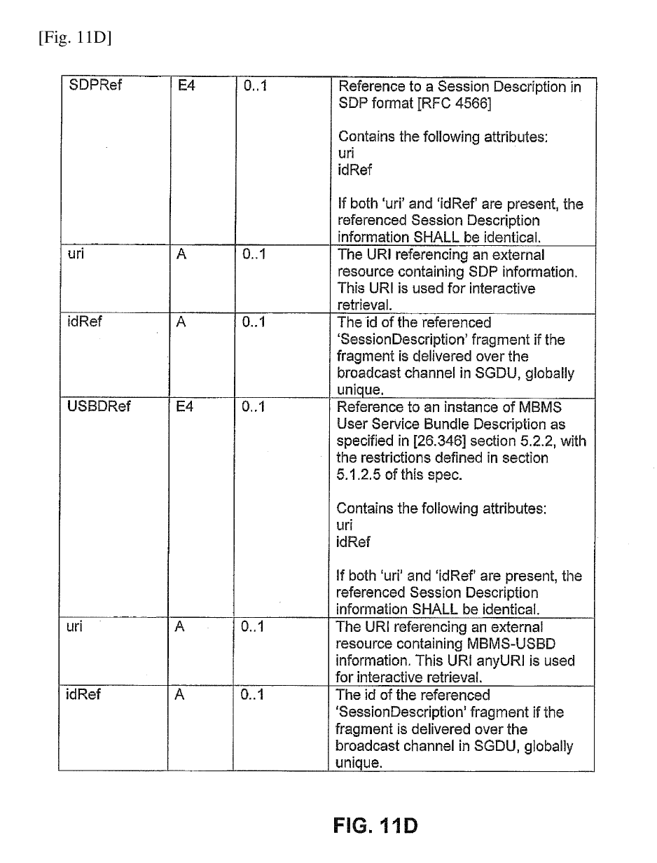

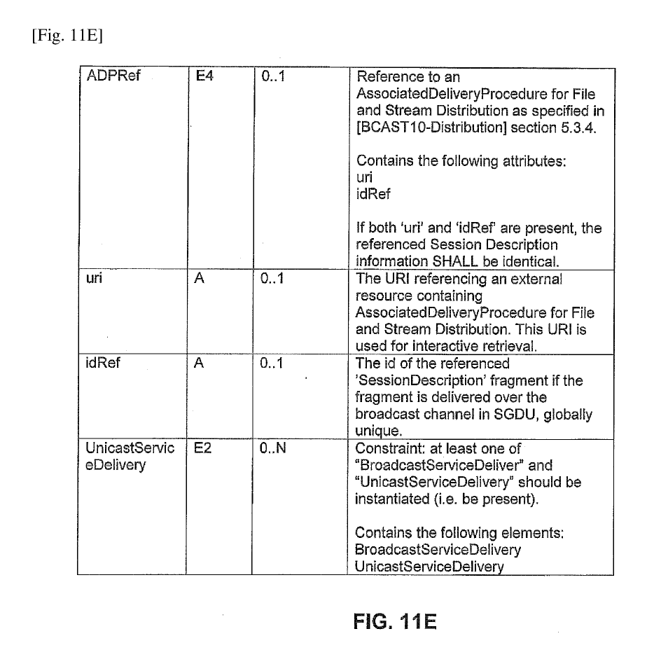

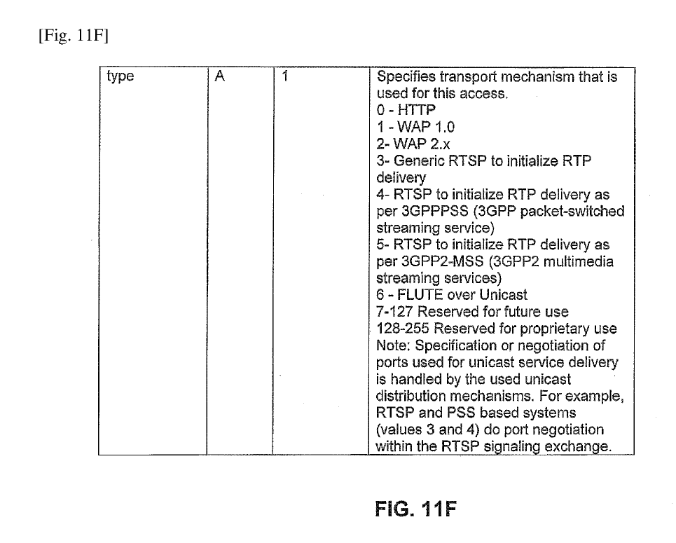

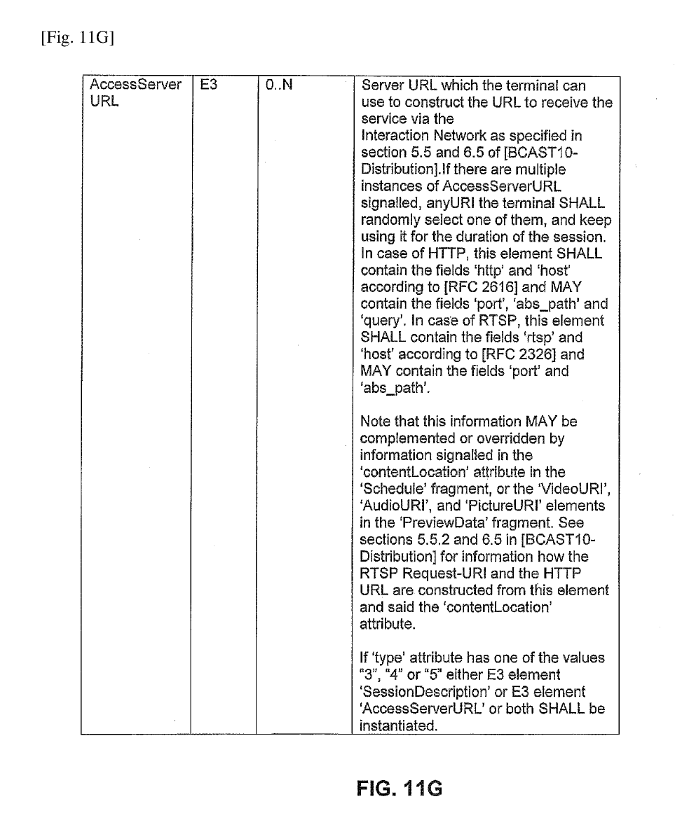

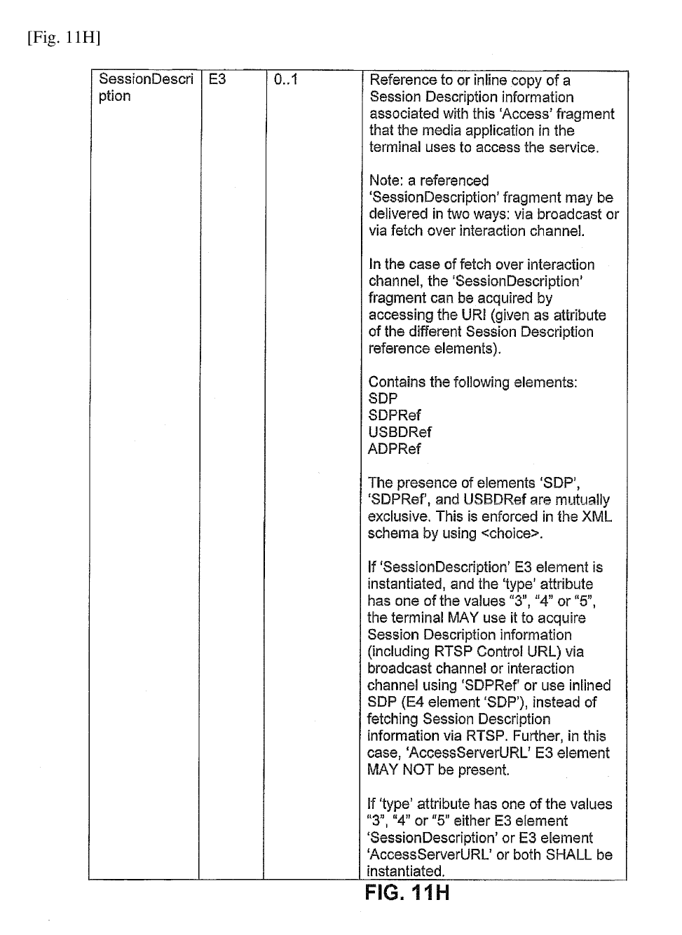

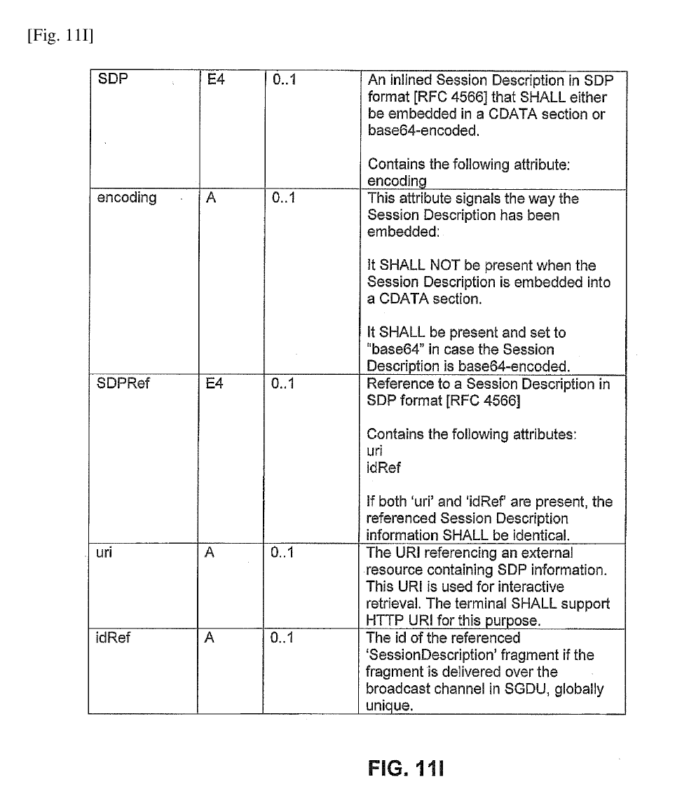

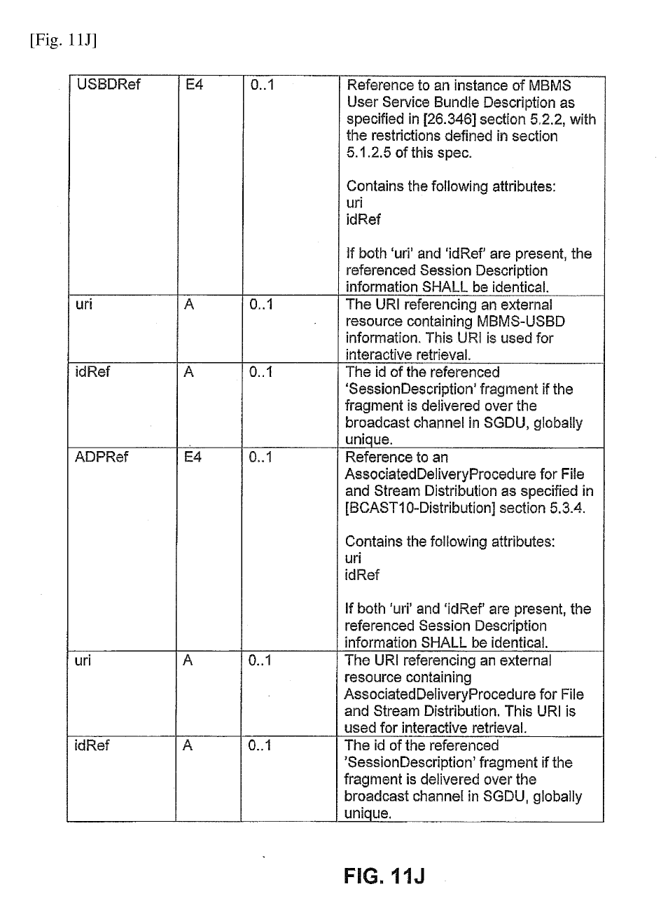

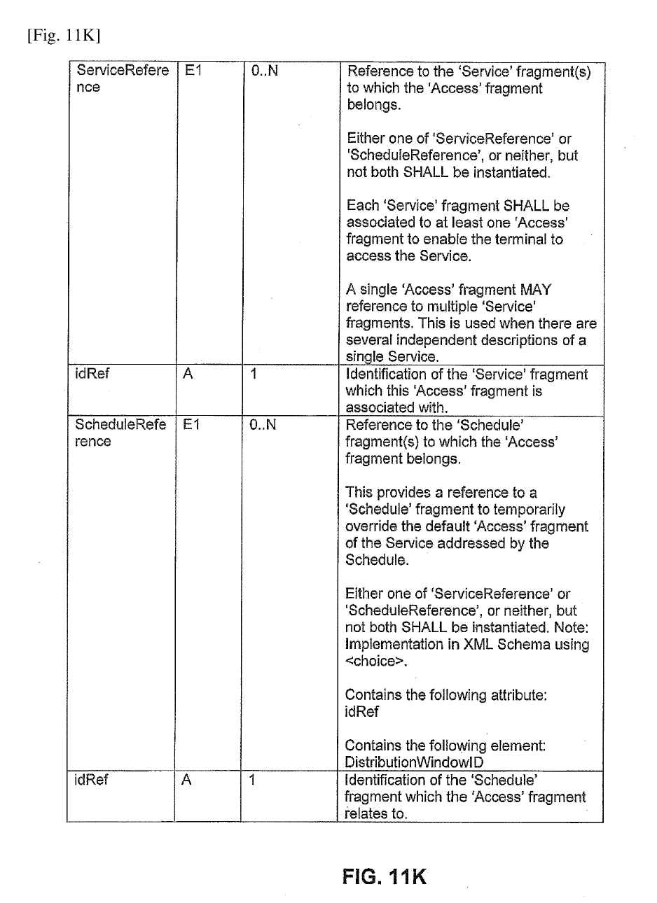

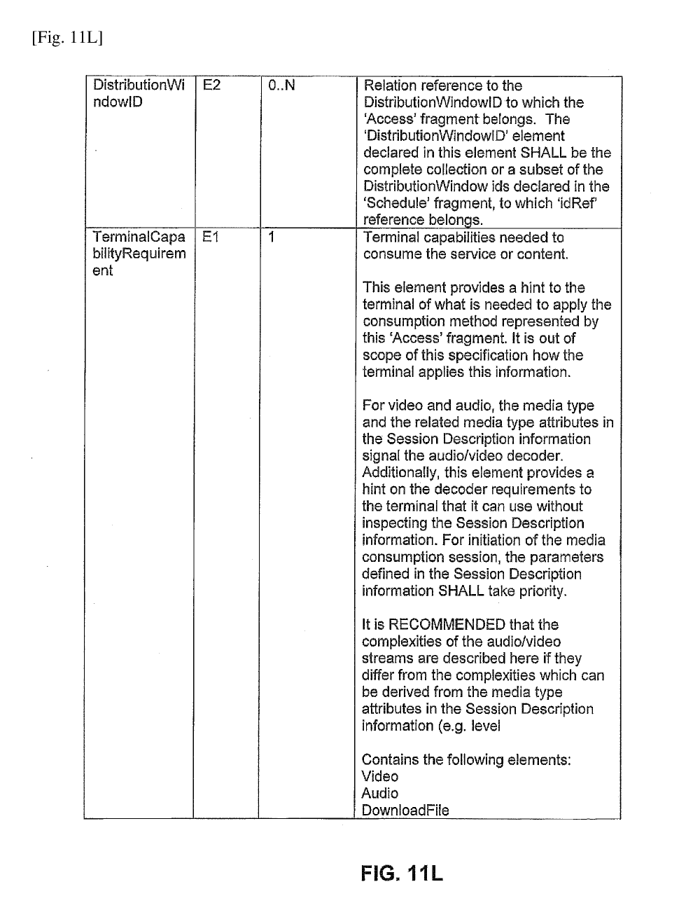

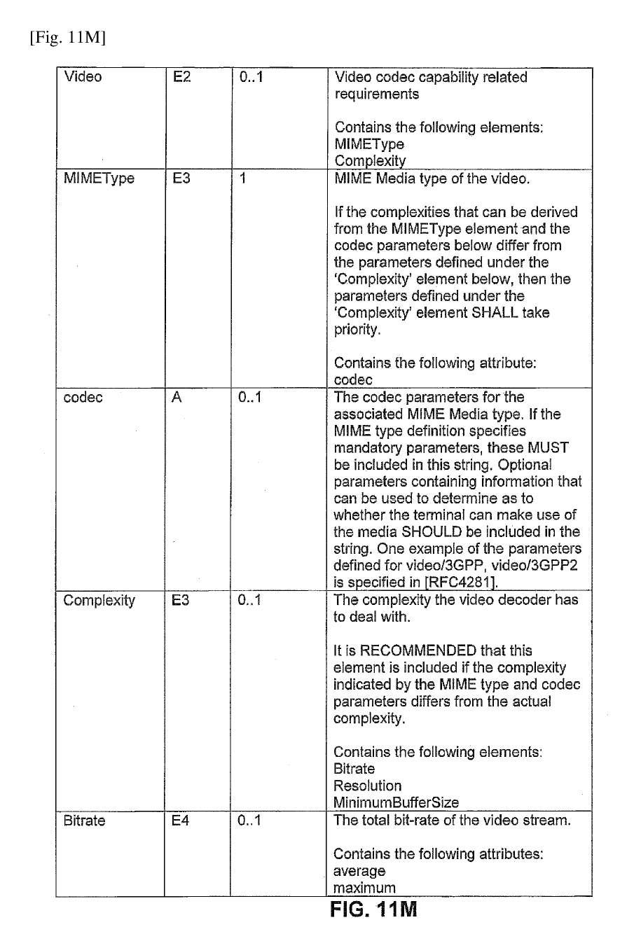

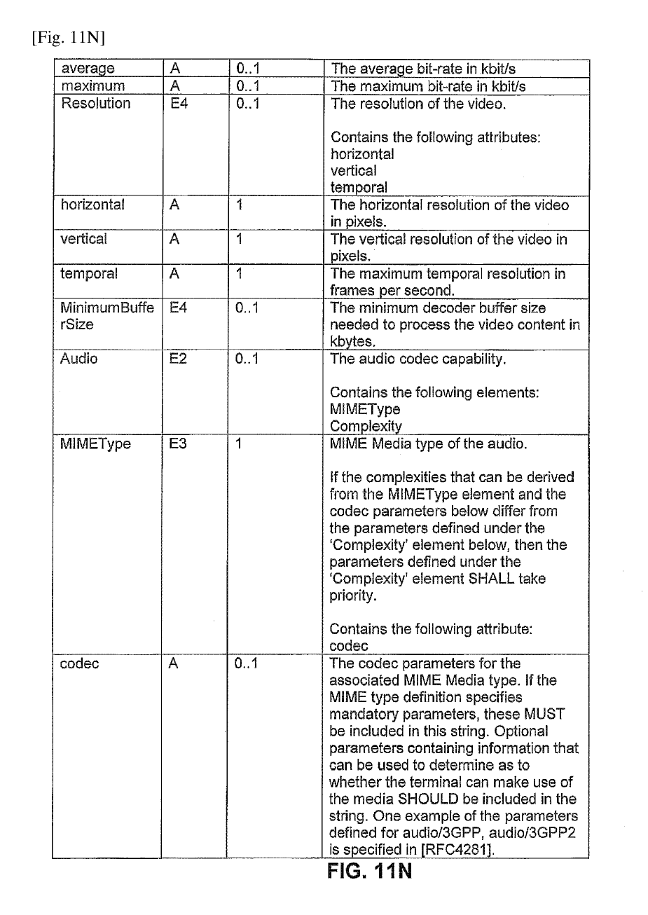

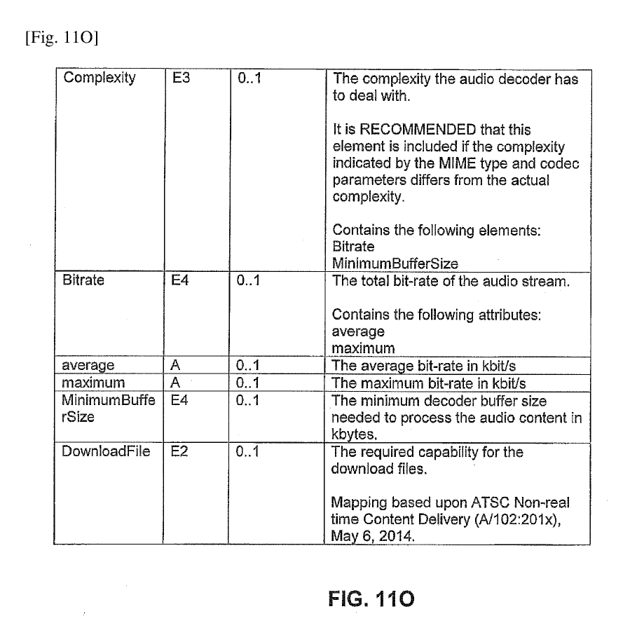

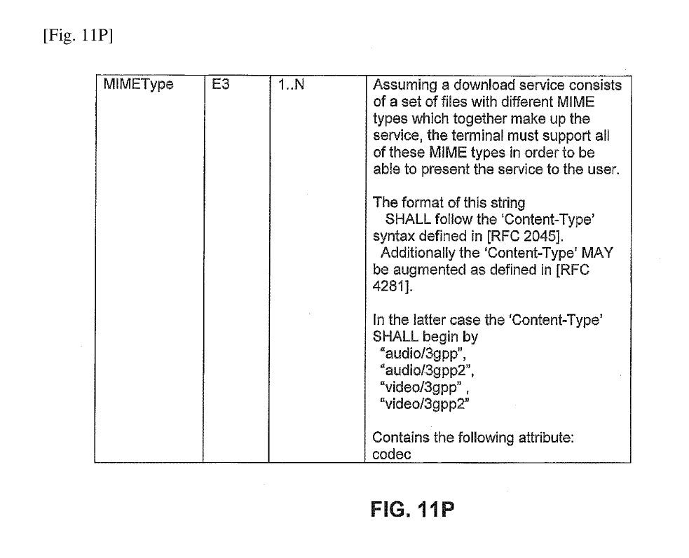

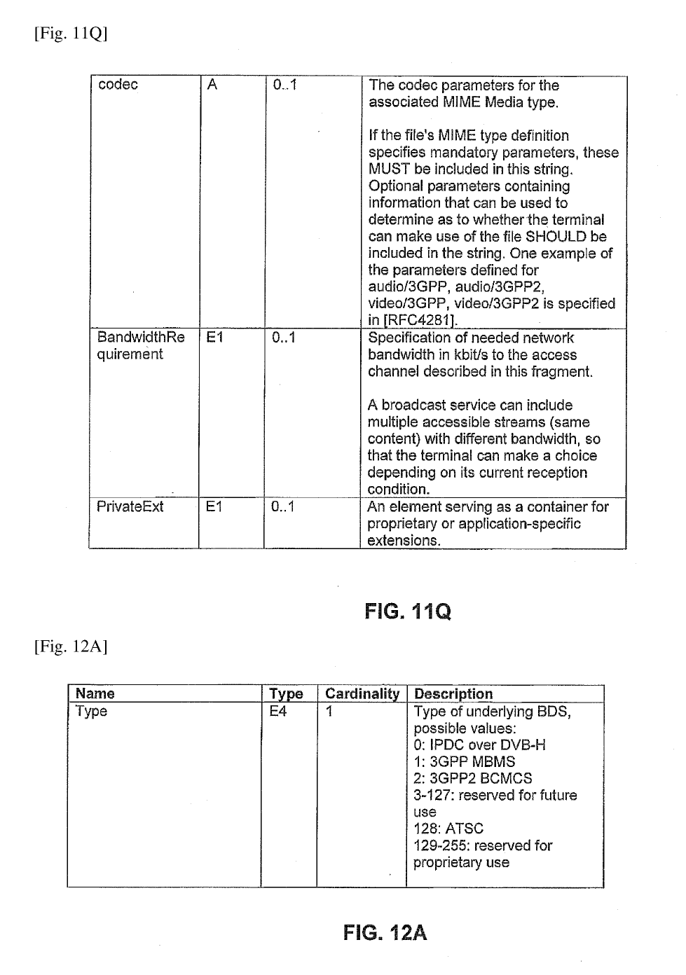

Referring to FIGS. 11A-11Q, an exemplary Access Fragment is illustrated, with particular modifications to Open Mobile Alliance, Service Guide for Mobile Broadcast Services, Version 1.0.1, Jan. 9, 2013, incorporated by reference herein it is entirety. The AccessType element may be modified to include a constraint of at least one of “BroadcastServiceDelivery” and “UnicastServiceDelivery” should be instantiated. Thus either or both of the elements “BroadcastServiceDelivery” and “UnicastServiceDelivery” is required to be present. In this manner, the AccessType element provides relevant information regarding the service delivery via BroadcastServiceDelivery and UnicastServiceDelivery elements, which facilitates a more flexible access fragment.

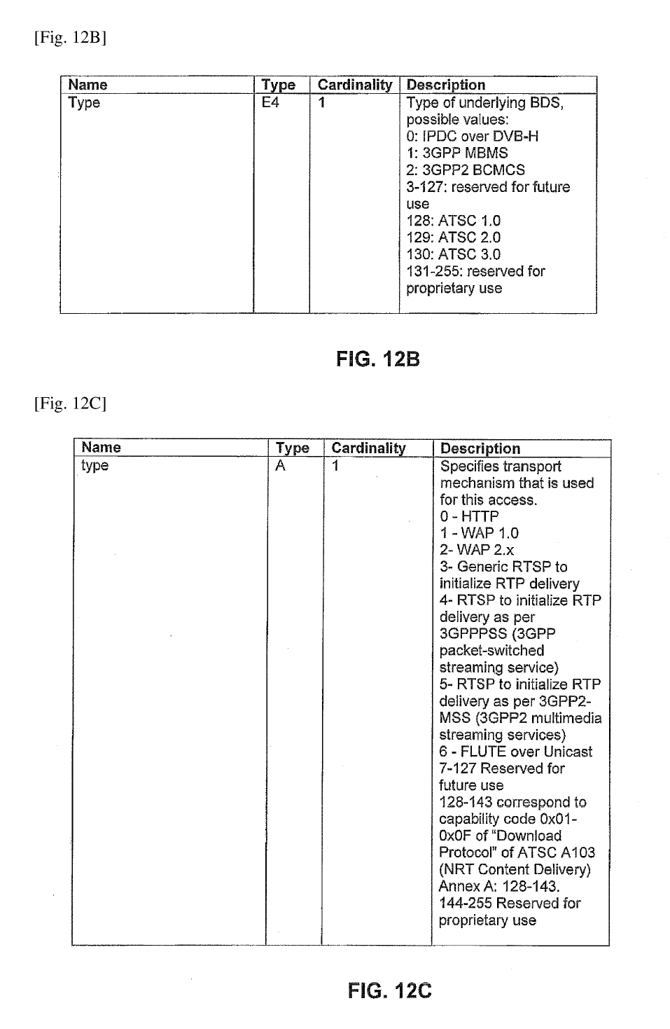

The BDSType element is an identifier of the underlying distribution system that the Access fragment relates to, such as a type of DVB-H or 3GPP MBMS, is preferably a required element (cardinality=1), rather than being an optional element (cardinality=0..1). The Type sub-element of the BDSType element is preferably a required element (cardinality=1), rather than being an optional element (cardinality=0..1). Additional information regarding Type sub-element is provided below in relation with FIG. 12A and FIG. 12B. The Version sub-element of the BDSType element is preferably a required element (cardinality=1), rather than being an optional element (cardinality=0..1).

The SessionDescription element is a reference to or inline copy of a Session Description information associated with this Access fragment that the media application in the terminal uses to access the service. The Version sub-element of the BDSType element is preferably an optional element (cardinality=0..1), rather than being a required element (cardinality=1). Alternatively the SessionDescription element should be omitted.

The UnicastServiceDelivery element may be modified to include a constraint of at least one of “BroadcastServiceDelivery” and “UnicastServiceDelivery” should be instantiated. In this manner, the UnicastServiceDelivery element may include both BroadcastServiceDelivery and UnicastServiceDelivery, which facilitates a more flexible access fragment.

The TerminalCapabilityRequirement describes the capability of the receiver or terminal needed to consume the service or content. The TerminalCapabilityRequirement element is preferably a required element (cardinality=1), rather than being an optional element (cardinality=0..1).

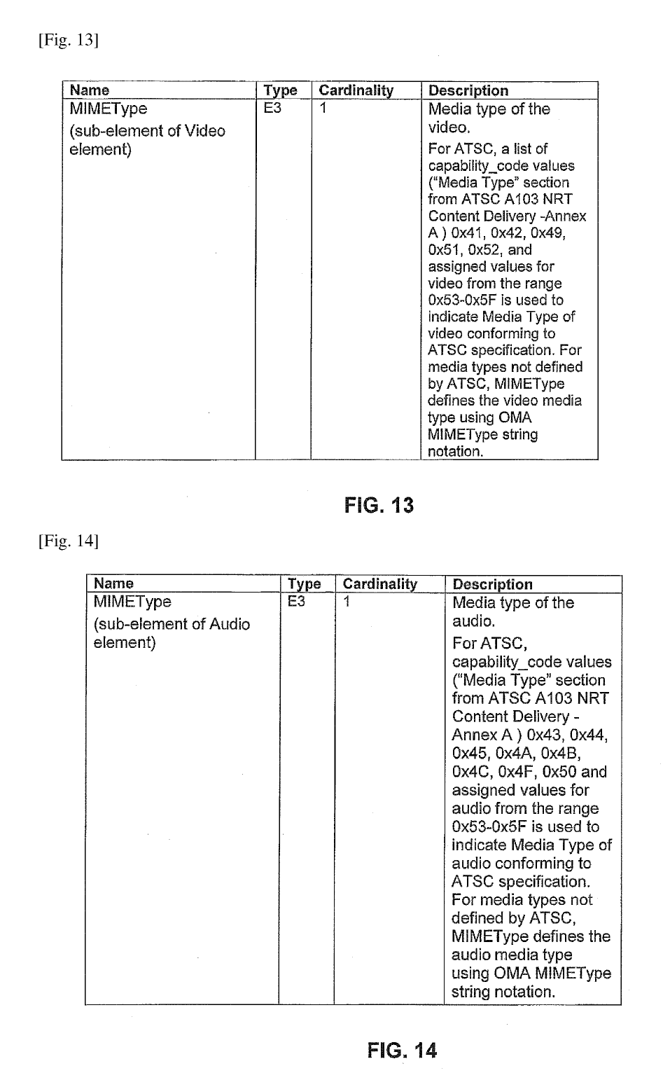

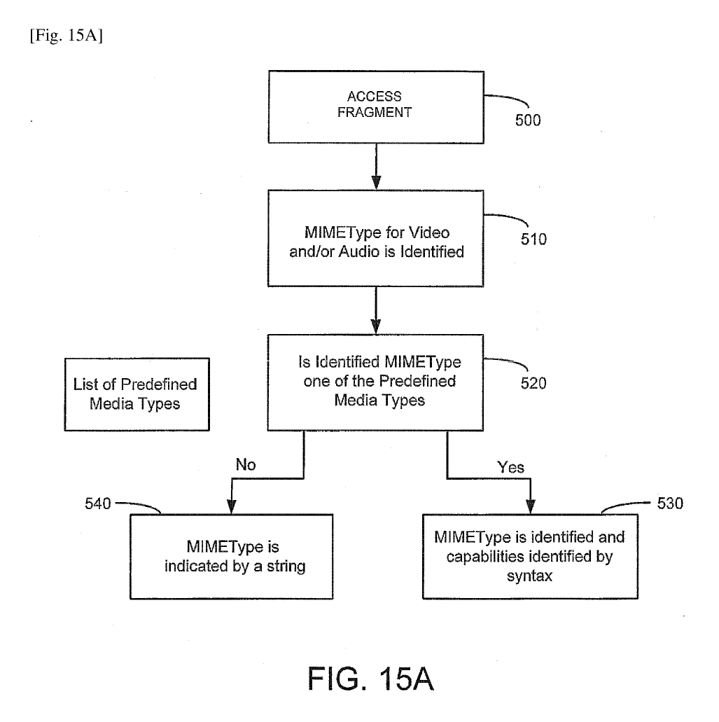

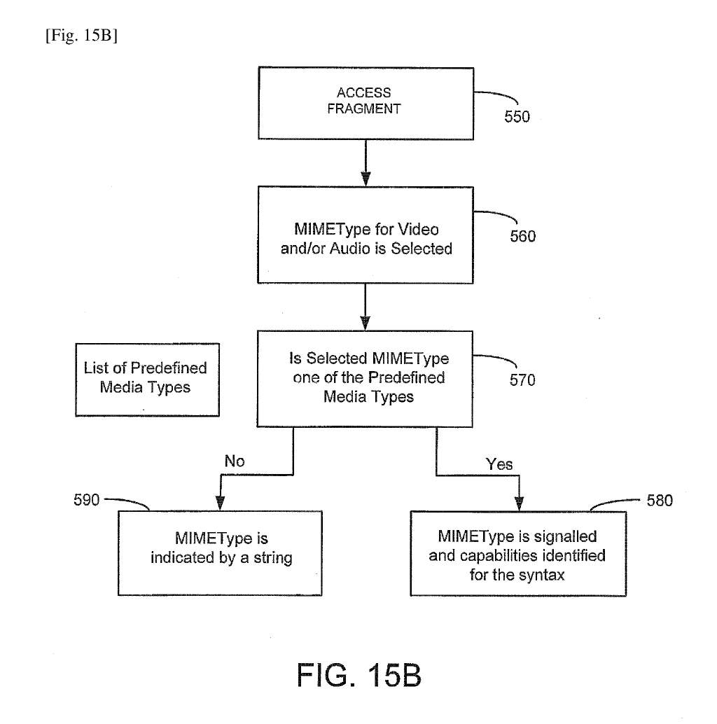

The MIMEType describes the Media type of the video. The MIMEType element is preferably a required element (cardinality=1), rather than being an optional element (cardinality=0..1). Additional information regarding MIMEType sub-element is provided below in relation with FIG. 13, FIG. 14, FIG. 15.

Some elements and attributes of the Access Fragment should be omitted, including FileDescription elements and attributes related to the FLUTE protocol and the RFC 3926. Other elements and attributes of the Access Fragment should be omitted, including KeyManagementSystem elements related to security elements and attributes. Yet other elements and attributes of the Access Fragment should be omitted, including ServiceClass, ReferredSGlnfo, BSMSelector, idRef, Service, PreviewDataReference, idRef, usage, NotificationReception, IPBroadcastDelivery, port, address, PollURL, and PollPeriod.

Referring to FIG. 12A, the Type sub-element of the BroadcastServiceDelivery element may be modified to include a new type value of 128: ATSC in the range reserved for proprietary use. In this case the sub-element Version of the element BDSType in FIG. 11B can be used to signal the Version of ATSC used. As an example the Version could be “1.0” or “2.0” or “3.0” indicating together with Type sub-element (with value of 128 for ATSC) indicating ATSC 1.0, ATSC 2.0 and ATSC 3.0 respectively. Alternatively referring to FIG. 12B, the Type sub-element of the BroadcastServiceDelivery element may be modified to include new type values of 128: ATSC 1.0; 129: ATSC 2.0; 130: ATSC 3.0, in the range reserved for proprietary use.

Referring to FIG. 12C, the type attribute of the UnicastServiceDelivery may be modified to add a new type value from capability_code “Download Protocol” section from ATSC A103 (NRT Content Delivery) Annex A: 128-143: corresponding to capability_code 0x01-0x0F. Alternatively other capability_code's defined by ATSC could be mapped to the values for the type attribute in the range reserved for proprietary use. For example values 128 to 159 for type attribute could be mapped to capability_code values 0x81-0x9F.

In ATSC A103-NRT Content Delivery, capability signaling is done using capability codes. The capabilities descriptor provides a list of “capabilities” (download protocols, FEC algorithms, wrapper/archive formats, compression algorithms, and media types) used for an NRT service or content item (depending on the level at which the descriptor appears), together with an indicator of which ones are deemed essential for meaningful presentation of the NRT service or NRT content item. These are signaled via capabilities_descriptor( ) or optionally via Service and Content fragments.

It is proposed to indicate the required device capabilities by using and extending the TerminalCapabilityRequirement element in Access fragment of OMA BCAST Service guide. TerminalCapabilityRequirement provides ability to indicate terminal capabilities needed to consume the service or content. These are extended with inclusion of capability_code values as defined by ATSC. Following discussion points describe reasoning and asserted benefits of this proposed design choice for capability indication:

Regarding signaling capabilities using TerminalCapabilityRequirement element in Access fragment:

In ATSC A103 the capability code signaling is done in Service and Content fragment by defining several elements and sub-elements. For making sure that a certain content is able to be consumed by the receiver capability code related elements in both service fragment and content fragment need to be parsed and examined since it is allowed that a capability is listed as non-essential for the service but essential for the content.

Since Access fragment's TerminalCapabilityRequirement already supports signaling information about media types, codecs it is proposed to use this for ATSC3 service announcement. Also TerminalCapabilityRequirement element in Access fragment provides ability to signal more precise information regarding video and audio codec, and “complexity” (including required average and maximum bitrate, horizontal, vertical and temporal resolution and minimum buffer size). This information is useful to determine the receiver's ability to consume the service.

It is asserted that the proposed use and extension of TerminalCapabilityRequirement avoids replication of similar functionality in other fragments.

Regarding essential and non-essential capabilities signaling:

It is also asserted that for the service announcement purpose signaling required capabilities via access fragment does not require further distinction between essential and non-essential capabilities as the purpose of this signaling is only to indicate to the user if receiver is capable of consuming a service. This purpose is satisfied as long as the receiver has resource support for indicated required capability for any one of the access fragment of the service.

Additionally since in A103 a capability listed as non-essential at the service level could in fact be essential for content further illustrates that the essential versus non-essential capabilities distinction is not beneficial and unnecessarily increases the complexity of service announcement.

Regarding inclusion of capability_codes in TerminalCapabilityRequirement:

A benefit of capability_code Media Types defined by ATSC is that they can provide more constrained description regarding AV media types compared to IANA defined MIME Media Types. As a result the MIMEType sub-element of Video and Audio element in Access Fragment's TerminalCapabilityRequirement element are extended to signal ATSC A103 defined capability_code if the media conforms to ATSC specification. If not then the MIMEType sub-element is used to signal IANA or unregistered MIME Media Type.

Similarly “type” attribute of Access fragment which provides information about the transport mechanism used for access is extended to indicate capability_code values from “Download Protocol” section of ATSC A103.

Referring to FIG. 13 and FIG. 14, the TerminalCapabilityRequirement of the Access Fragment relates to the capabilities needed to consume the service or content. Having this information in the Access Fragment, such as in the MIMEType, reduces the complexity of the decoder. For the MIMEType sub-element of the video sub-element of the TerminalCapabilityRequirement and the MIMEType sub-element of the audio sub-element of the TerminalCapabilityRequirement, it is desirable that the cardinality indicate that each of the elements (MIMEType sub-element of Video and MIMEType sub-element of Audio) are required (cardinality=1). It is further desirable to include Terminal Capability element and to signal capability_code Media Types in MIMEType sub-elements for Video and Audio sub-elements for particular media types, such as those defined by ATSC. By using these particular video and audio sub-elements being signaled in MIMEType, sufficiently well defined information may be provided for the terminal capability requirements to render the media without ambiguity. For media types not defined for the particular media types, such as those defined by ATSC, MIMEType defines the media type using a string notation.

A list of capability_code values (“Media Type” section from ATSC A103 NRT Content Delivery—Annex A) may be included to indicate the Media Type of video conforming to the ATSC specification. Media Type 0x41 AVC standard definition video (Section A.2.8), Media Type 0x42 AVC high definition video (Section A.2.9), Media Type 0x49 AVC mobile video (Section A.2.15), Media Type 0x51 Framecompatable 3D video (Side-by-Side) (Section A.2.23), and Media Type 0x52 Framecompatable 3D video (Top-and-Bottom) (Section A.2.24), and Media Type with assigned values by ATSC for the video from the range 0x53-0x5F to indicate its conformance to the ATSC specification.

For media types not defined by ATSC, MIMEType defines the video media type using OMA MIMEType string notation. For example if the terminal capability require video codec of type MEDX-ES, then since this is not one of the codec in the list of pre-defined capability_codes, the MIMEType will indicate string “video/MEDX-ES”.

In one embodiment following new capability_codes are defined:

0x53—HEVC legacy “profile” video

0x54—HEVC progressive “profile” video

where HEVC related to High efficiency video coding standard coded video, such as for example ISO/IEC 23008-2:2013, International Organization for Standardization, incorporated by reference herein in its entirety.

In another embodiment following new capability_codes are defined:

0x55—ATSC HEVC mobile “profile” video

0x56—ATSC HEVC fixed “profile” video

Alternatively, a new capability_code is defined to signal media types that are not in the list of defined capability_code Media Types.

For example:

0x57—HEVC legacy “profile” video

In one embodiment following new capability_codes are defined:

0x53—SHVC legacy “profile” video

0x54—SHVC progressive “profile” video

where SHVC related to scalable extension of High efficiency video coding standard coded video, such as for example, J. Chen, J. Boyce, Y. Ye, M. Hannuksela, “SHVC Draft 4”, JCTVC-O1008, Geneva, November 2013 incorporated by reference herein in its entirety; the scalable specification may include, J. Chen, J. Boyce, Y. Ye, M. Hannuksela, Y. K. Wang, “High Efficiency Video Coding (HEVC) Scalable Extension Draft 5, JCTVC-P1008, San Jose, January 2014, incorporated by reference herein in its entirety. The scalable specification may include “High efficiency video coding (HEVC) scalable extension Draft 6” Valencia, March 2014, incorporated by reference herein in its entirety.

In another embodiment following new capability_codes are defined:

0x55—ATSC SHVC mobile “profile” video

0x56—ATSC SHVC fixed “profile” video

Alternatively, a new capability_code is defined to signal media types that are not in the list of defined capability_code Media Types.

For example:

0x57—SHVC legacy “profile” video

The values used above are examples and other values may be used for signaling the capability_codes. For example values 0x58 and 0x59 could be used in place of values 0x53 and 0x54.

Example constraints which are related to defining a new capability_code for HEVC video as specified by ATSC are shown below:

By way of example, the capability_code value 0x54 shall represent the receiver ability to support HEVC video encoded in conformance with the ATSC video specification. The capability_code value 0x54 shall not appear along with capability_code values 0x42, 0x43, 0x22, 0x23, or 0x24, since each of these code values implies support for AVC with certain specified constraints.

Example constraints defined for HEVC video include following constraints, for example as defined in, B. Bros, W-J. Han, J-R Ohm, G. J. Sullivan, and T. Wiegand, “High efficiency video coding (HEVC) text specification draft 10”, JCTVC-L1003, Geneva, January 2013, incorporated by reference herein in its entirety.

general_progressive_source_flag in profile_tier_level syntax structure in Sequence Parameter Set (SPS) and Video Parameter Set (VPS) is required to be set equal to 1.

general_interlaced_source_flag flag in profile_tier_level syntax structure in Sequence Parameter Set (SPS) and Video Parameter Set (VPS) is required to be set equal to 0.

general_frame_only_constraint_flag in profile_tier_level syntax structure in Sequence Parameter Set (SPS) and Video Parameter Set (VPS) is required to be set equal to 1.

In one variant: If vui_parameters_present_flag in SPS is equal to 1 then it is required that field_seq_flag is set equal to 0 and frame_field_info_present_flag is set equal to 0.

In another variant: vui_parameters_present_flag in SPS is required to be set to 1 and it is required that field_seq_flag is set equal to 0 and frame_field_info_present_flag is set equal to 0.

vui_parameters_present_flag in SPS is required to be set to equal to 1, vui_timing_info_present_flag in SPS is required to be set equal to 1, vui_hrd_parameters_present_flag in SPS is required to be set equal to 1, and:

in one variant: fixed_pic_rate_general_flag[i] is required to be set equal to 1 or fixed_pic_rate_within_cvs_flag [i] is required to be set equal to 1 for all value of i in the range 0 to maxNumSubLayersMinus1, inclusive.

in another variant: fixed_pic_rate_general_flag[i] is required to be set equal to 1 or fixed_pic_rate_within_cvs_flag [i] is required to be set equal to 1 for i equal to maxNumSubLayersMinus1.

Similar other constraints may be defined for other HEVC and/or SHVC profiles defined by ATSC.

A list of capability_code values (“Media Type” section from ATSC A103 NRT Content Delivery—Annex A) may be included to indicate the Media Type of audio conforming to the ATSC specification. Media Type 0x43 AC-3 audio (Section A.2.10), Media Type 0x44 E-AC-3 audio (Section A.2.11), Media Type 0x45 MP3 audio (Section A.2.12), Media Type 0x4A HE AAC v2 mobile audio (Section A.2.16), Media Type 0x4B HE AAC v2 level 4 audio (Section A.2.17), Media Type 0x4C DTS-HD audio (Section A.2.21), Media Type 0x4F HE AAC v2 with MPEG Surround (Section A.2.21), Media Type 0x50 HE AAC v2 Level 6 audio (Section A.2.22), and Media Type with the assigned values for the audio from the range 0x53-0x5F to indicate its conformance to the ATSC specification.

For media types not defined by ATSC, MIMEType defines the audio media type using OMA MIMEType string notation. For example if the terminal capability require audio codec of type AUDX-ES, then since this is not one of the codec in the list of pre-defined capability_codes, the MIMEType will indicate string “audio/AUDX-ES”

In one embodiment following new capability_codes are defined for ATSC selected audio coding standard with additional constraints as defined by ATSC:

0x57—ATSC 3 Audio 1

0x58—ATSC 3 Audio 2

Referring to FIG. 15A, an exemplary flow is illustrated for the signaling of the predefined media types, including audio and video. The access fragment is received 500 by the terminal device. For the received access fragment, the MIMEType for video and/or audio is identified 510. Next, the terminal device determines if the MIMEType is one of the predefined media types 520. If the MIMEType is one of the predefined media types 520, then the MIMEType is identified and the capabilities required to render the content are likewise identified by the syntax 530. One example of predefined media types are the capability_codes of ATSC for video and audio as described above. If the MIMEType is not one of the predefined media types 520, then the MIMEType is indicated by a string value, indicating a media type not further defined by the syntax, and the capabilities required to render the content are not further defined by the syntax 540.

Referring to FIG. 15B, another exemplary flow is illustrated for the signaling of the predefined media types, including audio and video. The access fragment is constructed 550 by the encoding device/broadcast or broadband server side. For the constructed access fragment, the MIMEType for video and/or audio is selected 560. For example the selection is based on the codec used and other media type related parameters used for the media (audio, video, etc.) encoding. Next, the encoder determines if the MIMEType is one of the predefined media types 570. In some cases these may be predefined media types with per defined constraints as defined above. If the MIMEType is one of the predefined media types 570, then the MIMEType is signalled and the capabilities required to render the content are likewise signalled for the syntax 580. One example of predefined media types are the capability_codes of ATSC for video and audio as described above. If the MIMEType is not one of the predefined media types 570, then the MIMEType is signalled by a string value, indicating a media type not further defined by the syntax, and the capabilities required to render the content are not further defined by the syntax 590.

In some embodiments, it is desirable to include additional syntax elements and/or attributes for the service guide element. For example, the new elements and/or attributes may include:

VideoRole

AudioMode

CC

Presentable

url

These new elements can be addressed by a syntax element that the system shall enable announcement using the receiver's on-screen program guide of Components within a given Service that would be helpful to a viewer (e.g., multi-view service information, alternative audio tracks, alternative subtitles, etc.).

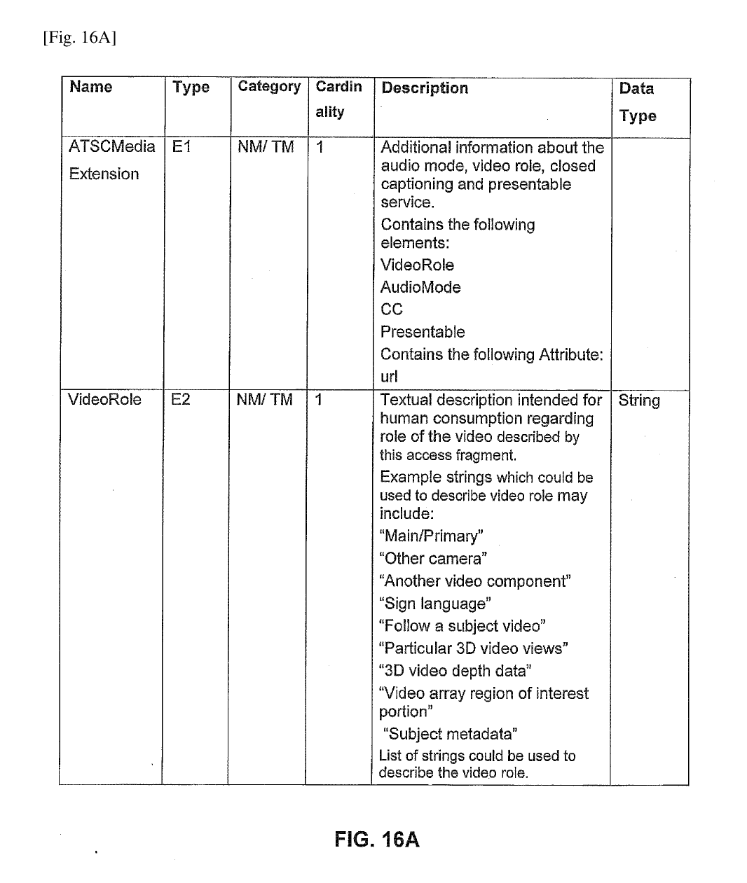

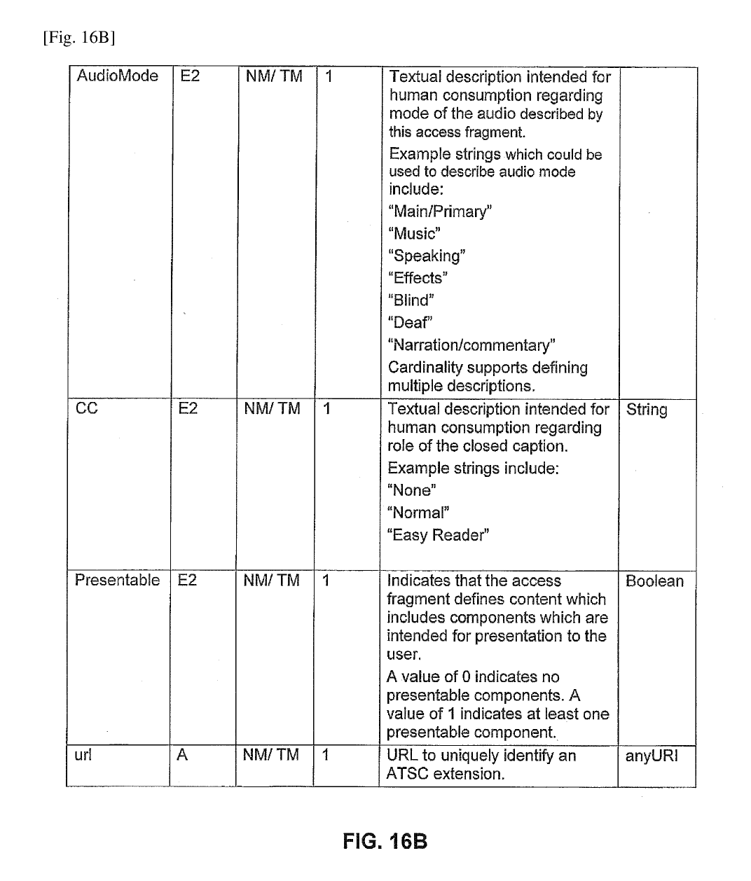

Referring to FIGS. 16A-16B, these are preferably added to the access fragment, but may also or alternatively be added to the Content fragment or alternatively be added to the Service fragment. For example, these may be included within a PrivateExt element in Access fragment and/or Content fragment and/or Service fragment. The cardinality is preferably selected to be 1..N (for VideoRole and AudioMode elements) because more than one may be selected in some cases, such as, the VideoRole being the “Primary (default) video” and simultaneously a “3D video right/left view”.

In an alternative embodiment, instead of using Data Type “string” for the VideoRole, AudioMode, CC, Presentable elements other data types may be used. For example the Data Type unsignedInt may be used. In another example a string of limited length may be used, e.g. string of 5 digits.

In another embodiment a list of enumerated values may be defined for VideoRole, Audio Mode and CC and then represented as values for those elements.

For example, for VideoRole the following values may be pre-defined and then used to signal the value.
0 Main/Primary video
1 Other Camera view
2 Another video component
3 Sign language
4 Follow a subject video
5 Particular 3D video views
6 3D video depth data
7 Video array region of interest portion
8 Subject metadata
9 Undefined
10 Reserved

For example, for AudioMode the following values may be pre-defined and then used to signal the value
0 Main/Primary
1 Music
2 Speaking
3 Effects
4 Blind
5 Deaf
6 Narration/commentary
7 Undefined
8 Reserved

For example, for CC the following values may be pre-defined and then used to signal the value
0=None
1=Normal
2=Easy Reader

An example XML schema syntax for the above additions is shown below

```
      <xs:element name=“ATSC3MediaExtension”
type=“ATSC3MediaExtensionType” minOccurs=“0” maxOccurs=“unbounded”/>
<xs:complexType name=“ATSC3MediaExtensionType”>
      <xs:sequence>
            <xs:element name=“VideoRole” type=“LanguageString”
      minOccurs=“1” maxOccurs=“1”/>
            <xs:element name=“AudioMode” type=“LanguageString”
      minOccurs=“1”maxOccurs=“1”/>
            <xs:element name=“CC” type=“LanguageString” minOccurs=“1”
      maxOccurs=“1”/>
            <xs:element name=“Presentable” type=“boolean” minOccurs=“1”
      maxOccurs=“1”/>
      </xs:sequence>
      <xs:attribute name=“url” type=“xs:anyURI” use=“required”/>
</xs:complexType>
```

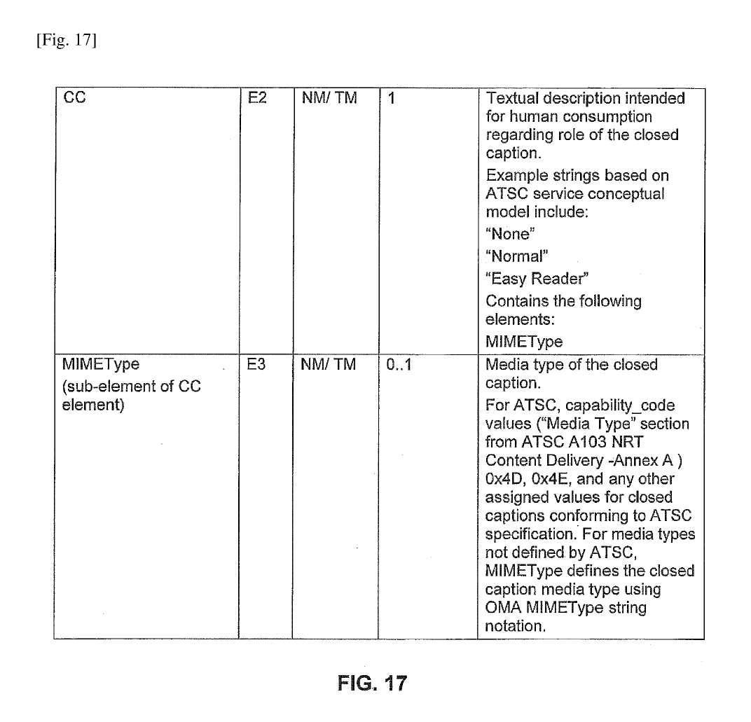

Referring to FIG. 17, another exemplary embodiment of the CC is illustrated. A list of capability_code values (“Media Type” section from ATSC A103 NRT Content Delivery—Annex A) may be included to indicate the Media Type of closed captioning conforming to the ATSC specification. Media Type 0x4D CFF-TT (Section A.2.19), Media Type 0x4E CEA-708 captions (Section A.2.20), may be used to define the ATSC closed captioning.

An example XML schema syntax for the above modification is shown below.

```
<xs:element name=“ATSCMediaExtension” type=“ATSCMediaExtensionType”
minOccurs=“0” maxOccurs=“unbounded”/>
<xs:complexType name=“ATSCMediaExtensionType”>
      <xs:sequence>
            <xs:element name=“VideoRole” type=“LanguageString”
      minOccurs=“1” maxOccurs=“1”/>
            <xs:element name=“AudioMode” type=“LanguageString”
      minOccurs=“1” maxOccurs=“1”/>
            <xs: complexType name=“CC” type=“LanguageString”
      minOccurs=“1” maxOccurs=“1”/>
                  <xs:sequence>
                        <xs:element name=“MIMEType” type=“ ”xs:string“”
                  minOccurs=“0” maxOccurs=“1”/>
                  </xs:sequence>
            </xs:complexType>
            <xs:element name=“Presentable” type=“boolean” minOccurs=“1”
      maxOccurs=“1”/>
      </xs:sequence>
      <xs:attribute name=“url” type=“xs:anyURI” use=“required”/>
</xs:complexType>
```

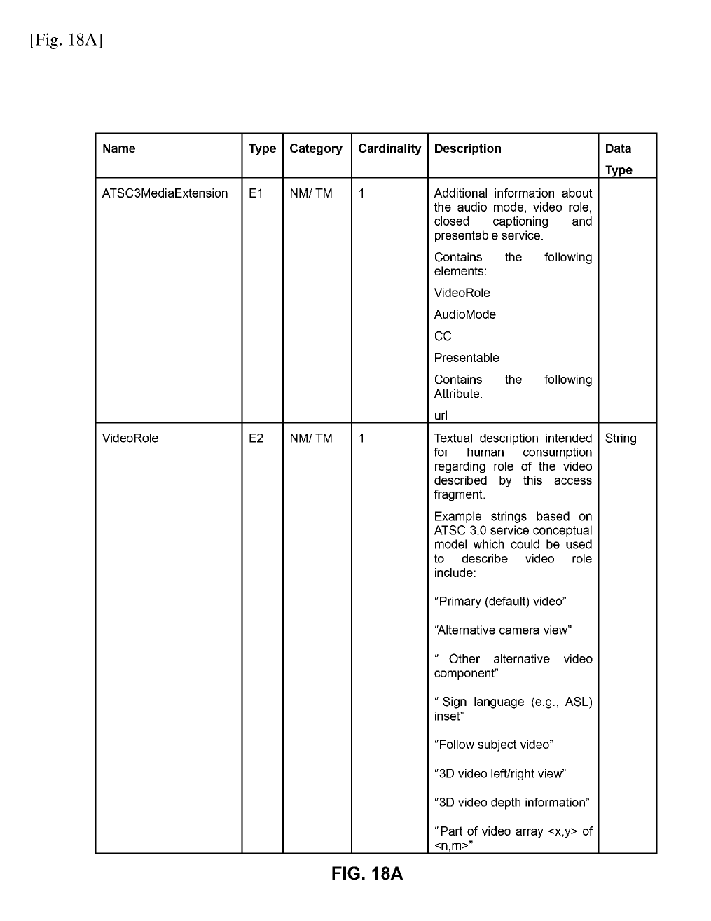

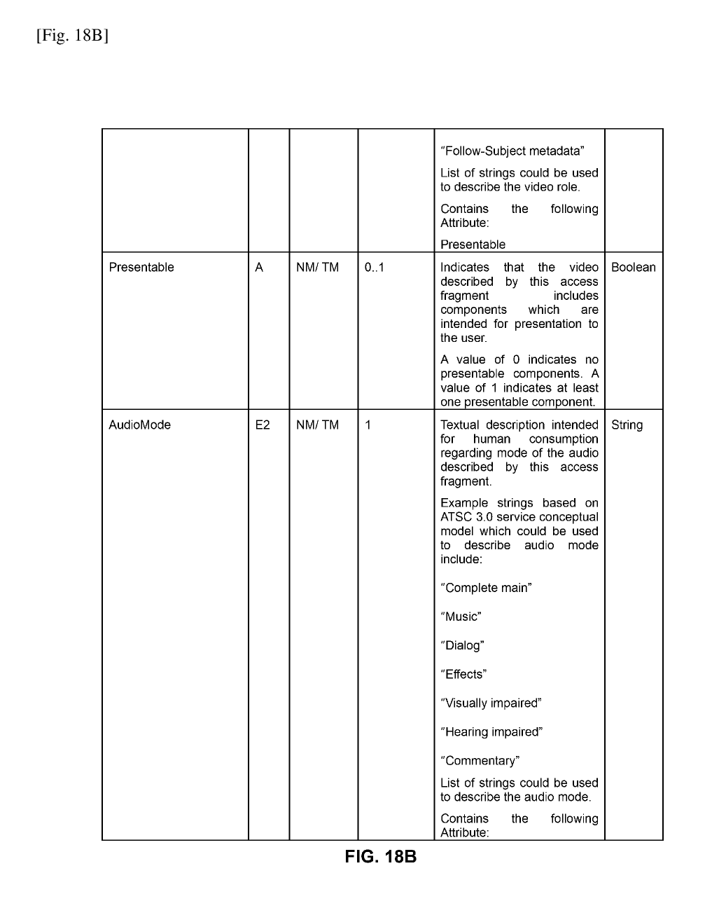

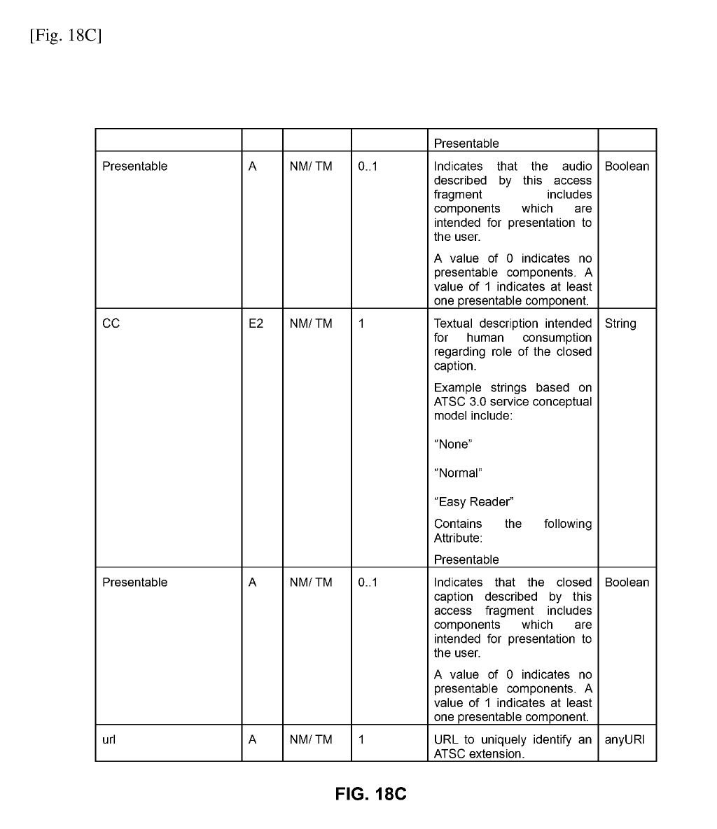

Referring to FIGS. 18A, 18B and 18C, another exemplary embodiment of the Presentable is illustrated. The Presentable element may instead be signalled as attribute for each of the VideoRole, AudioMode, CC elements as shown in FIGS. 18A, 18B and 18C.

An example XML schema syntax for the above modification is shown below.

An example XML schema syntax for the above additions is shown below.

```
<xs:element name=“ATSC3MediaExtension” type=“ATSC3MediaExtensionType”
minOccurs=“0” maxOccurs=“unbounded”/>
<xs:complexType name=“ATSC3MediaExtensionType”>
      <xs:sequence>
            <xs:element name=“VideoRole” type=“LanguageString”
            minOccurs=“1” maxOccurs=“1”>
            <xs:complexType>
                  <xs:attribute name=“Presentable” type=“boolean”
                  minOccurs=“0” maxOccurs=“1”/>
            </xs:complexType>
            </xs:element>
            <xs:element name=“AudioMode” type=“LanguageString”
            minOccurs=“1” maxOccurs=“1”>
            <xs:complexType>
                  <xs:attribute name=“Presentable” type=“boolean”
                  minOccurs=“0” maxOccurs=“1”/>
            </xs:complexType>
            </xs:element>
            <xs:element name=“CC” type=“LanguageString” minOccurs=“1”
            maxOccurs=“1”>
            <xs:complexType>
                  <xs:attribute name=“Presentable” type=“boolean”
                  minOccurs=“0” maxOccurs=“1”/>
            </xs:complexType>
            </xs:element>
      </xs:sequence>
      <xs:attribute name=“url” type=“xs:anyURI” use=“required”/>
</xs:complexType>
```

In other embodiments some of the elements above may be changed from E2 to E1.

In other embodiments the cardinality of some of the elements may be changed. For example cardinality may be changed from “1” to “0..1” or cardinality may be changed from “1” to “1..N” or cardinality may be changed from “1” to “0..N”.

It is to be understood that the claims are not limited to the precise configuration and components illustrated above. Various modifications, changes and variations may be made in the arrangement, operation and details of the systems, methods, and apparatus described herein without departing from the scope of the claims.

1. A method for decoding a service guide associated with a video bitstream comprising:
(a) receiving a service description within said service guide;
(b) receiving a video extension within said service description that is mandatory for network support and is mandatory for terminal support;
(c) wherein said video extension has a data type of string used to describe the role of the video extension as a textual description regarding the said video extension;
(d) receiving an audio extension within said service description that is mandatory for network support and is mandatory for terminal support;
(e) wherein said audio extension has a data type of string used to describe the role of the audio extension as a textual description regarding the said audio extension;
(f) receiving a closed caption extension within said service description that is mandatory for network support and is mandatory for terminal support;
(g) wherein said closed caption extension has a data type of string used to describe the role of the closed caption extension as a textual description intended regarding the said closed caption extension;
(h) decoding said service guide including said video extension, said audio extension, and said closed caption extension.

2. The method of claim 1 wherein textual description for said video extension includes at least one of (1) “primary video”, (2) “Alternative camera view”, (3) “Other alternative video component”, (4) “Sign language inset”, (5) “Follow subject video”, (6) “3D video left/right view”, (7) “3D video depth information”, (8) “Part of video array <x,y> of <n,m>”, (9) “Follow-Subject metadata”.

3. The method of claim 1 wherein textual description for said audio extension includes at least one of (1) “Complete main”, (2) “Music”, (3) “Dialog”, (4) “Effects”, (5) “Visually impaired”, (6) “Hearing impaired”, (7) “Commentary”.

4. The method of claim 1 wherein textual description for said closed caption extension includes at least one of (1) “Normal”, (2) “Easy reader”.

5. The method of claim 1 further comprising selecting a media bitstream to provide based upon said decoded service guide.

6. The method of claim 1 further comprising rendering content of said decoded service guide on a display.

7. The method of claim 1 further comprising accessing a media bitstream based upon said decoded service guide.
